(19) United States
(12) Patent Application Publication
(10) Pub. No.: US 2022/0250277 A1
(43) Pub. Date: Aug. 11, 2022

(54) PRODUCTION PLANT AND METHOD FOR PRODUCING CONCRETE TUBBING IN A TUNNEL LINING SYSTEM

(71) Applicant: HERRENKNECHT AG, Schwanau (DE)

(72) Inventor: Stefan MEDEL, Gengenbach (DE)

(21) Appl. No.: 17/599,075

(22) PCT Filed: Apr. 7, 2020
(86) PCT No.: PCT/EP2020/059943

§ 371 Date: Sep. 28, 2021

(30) Foreign Application Priority Data
Apr. 7, 2019 (DE) 10 2019 109 084.9

(51) Int. Cl. B28B 5/04; B28B 7/00; B28B 11/24; B28B 15/00; B28B 17/00; E21D 11/08

(52) U.S. Cl. CPC B28B 5/04; B28B 7/0014; B28B 7/0044; E21D 11/086; B28B 15/002; B28B 17/0081; B28B 11/245

(57) ABSTRACT

The invention relates to a production plant for producing concrete tubbing (500) for a tunnel lining system having at least one formwork (10) for producing the concrete tubbing (500), wherein the production plant is designed either as a carousel system, which has at least one production line (200) with at least two work stations (210, 220, 230, 240, 250, 260) and with at least one transport route (110) between the at least two work stations (210, 220, 230, 240, 250, 260), each for executing at least one operation step in the production of the concrete tubbing (500), or as a stationary plant with at least two stationary formworks (10), wherein the operation steps necessary for producing the concrete tubbing (500) are each executed on the formworks (10), and with at least one curing station (300), for curing a concrete filled in the formwork (10) for producing the concrete tubbing (500). At least one robot (140) is provided to execute the at least one operation step on one of the at least two work stations (210, 220, 230, 240, 250, 260) or two formworks (10) are provided. At least one route (120) is provided which extends at least partially along or transverse to the at least one production line (200) or along or transverse to the formwork (10). At least one travel element (130) is provided on which the at least one robot (140) is arranged with a base (131) and with which the at least one robot (140) can be moved at least partially along or transverse to the at least one production line (200) or formwork (10).

The invention relates to a production plant for producing concrete tubbing of a tunnel lining system having at least one formwork for producing the concrete tubbing, wherein the production plant is provided either as a carousel plant which, for carrying out in each case at least one operating step for producing the concrete tubbing, has at least one production line having at least two workstations and having at least one transport route between the at least two workstations, or as a stationary plant having at least two formworks which are disposed so as to be stationary, wherein the required operating steps for producing the concrete tubbing are in each case carried out at the formworks, and having at least one curing station for curing concrete which for producing the concrete tubbing has been filled into the formwork. The invention furthermore relates to a method and a control therefor.

In order for concrete tubbing to be produced, the individual operating steps for producing a concrete tubbing are carried out manually. Besides the operating costs arising here, the work to be carried out is monotonous and stressful to the operators. Furthermore, the activities are carried out using heavy objects such that there is a risk of injury. Despite the repetitive activities, it is at the same time necessary for the works to be carried out with very high precision.

It is therefore an object of the invention to alleviate at least some aspects of the aforementioned issues.

The object is achieved in that at least one robot is provided for carrying out the at least one operating step at one of the at least two workstations or at least two formworks, in that at least one travel route which at least partially extends along or transversely to the at least one production line, or along or transversely to the formwork, is provided, in that at least one travel element on which the at least one robot is disposed by way of a base and by way of which the at least one robot is at least partially displaceable along or transversely to the at least one production line or formwork is provided.

As a result thereof, it is possible to carry out automation of the production plant in a simple manner. The required precision can at the same time be retained here.

A further teaching of the invention provides that the base of the at least one robot on the at least one travel element is movable along the travel element into the workstation.

A further teaching of the invention provides that the travel route is disposed, preferably on pillars, above the workstation or the formworks. By disposing the travel route above the workstations or of the formworks it is possible to engage from above into the region of the workstations with the robot, and to reach the required operating locations in a simple manner in terms of the formwork in place.

A further teaching of the invention provides that the travel route has in each case at least one track on both sides along or transversely to the at least one production line or formwork. It is advantageous here for the travel element to be at least one crossbeam which by way of the ends thereof is in each case displaceable on a track, and/or on which the base of the at least one robot is disposed so as to be displaceable across the workstation. By dividing the travel route in tracks it is possible to either use a displaceable gantry or, when the travel route is disposed above the workstations, to enable a precise displacement here. If a crossbeam is used here, the robot can in turn be readily disposed in the space of the workstations. If a base which is likewise displaceable is disposed on the crossbeam here, the degree of freedom in terms of the disposal of the robot in the space of the workstations is increased in a simple manner.

A further teaching of the invention provides that the robot has a tool and is embodied such that the tool is movable and pivotable in the space of the workstation. It is advantageous here for the tool to be embodied so as to be replaceable on the robot. It is furthermore advantageous for the replaceable tool to be contained in a storage space which is displaceable by the robot or situated on the workstation. If the robot is provided with arms and articulations as well as rotary joints and drives, it is furthermore possible for the degree of freedom of the disposal of a tool, which is situated so as to be disposed on the robot, for example, in the space of the workstation to be increased in a simple manner. If the tool here is also embodied so as to be replaceable, a plurality of operating steps at one workstation can be carried out by the same robot. Depending on the type of the activities to be carried out, and in particular also on the size of the tools, it is advantageous here for the tools to be disposed directly so as to be able to move in the region of the robot or on the respective workstation. As a result thereof it is also possible for different operating steps to be carried out with the same tools in a simple manner. For example, a torque driver can be used for establishing or releasing fastenings, and at the same time also for carrying out other operating steps which require a rotational drive.

The tool is advantageously a torque driver, a brush, a roller, a measurement verification element, a nozzle, a scanner, a gripper, or a camera.

A further teaching of the invention provides that the at least one workstation is a station for opening or closing the formwork or a cover of the formwork, a station for retrieving the concrete tubbing; a station for cleaning the formwork, a station for preparing the formwork for subsequently introducing concrete, a station for equipping the formwork with at least one element of the concrete tubbing, a station for verifying the measurements of the formwork, a station for filling the formwork with concrete, and/or a station for treating the surface of the introduced concrete of the concrete tubbing. It is advantageous here for the at least one element to be a seal, a protective liner, a reinforcement element, a sensor, in particular a temperature sensor, a dewatering element, a plastic element, and/or an erector anchor.

A further teaching of the invention provides that at least two production lines which are disposed in parallel and have at least two parallel workstations are provided.

A further teaching of the invention provides that the robot is displaceable between at least two parallel workstations of the at least two parallel production lines.

A further teaching of the invention provides that at least one production plant for making reinforcements for the tubbings is disposed upstream, said tubbings preferably being temporarily stored in a store.

A further teaching of the invention provides that at least one workstation is of modular construction.

A further teaching of the invention provides that the curing station is constructed from individual curing chambers which are preferably embodied as a standard ISO container.

A further teaching of the invention provides that the curing station has a plurality of planes disposed on top of one another.

The object is furthermore achieved by a method for producing concrete tubbing of a tunnel lining system having at least one formwork, in particular by a production plant as claimed in one of claims 1 to 10, said method comprising the following steps:

1. disposing, preferably at the precise position, formwork in a respective workstation along at least one production line of the production plant;

2. if required, identifying the type of formwork in the workstation;

3. if required, picking up the tool required for carrying out an operating step by a robot;

4. displacing a base of the robot along a travel route and/or a crossbeam for the X/Y-alignment with a position required for carrying out the operating step at the workstation;

5. carrying out and completing the operating step by the robot using the tool required to this end;

6. if required, checking the completion of the operating step, preferably by the robot, using a tool conceived to this end;

7. if required, repeating steps 3 to 6 for carrying out a further operating step at the workstation;

8. transporting the formwork to the next workstation;

9. if required, repeating steps 3 to 8 for carrying out an operating step at the next workstation.

By using the method according to the invention it is possible to enhance the quality of the production of tubbings in a simple manner. At the same time the input of material in the production of tubbings can be precisely detected and evaluated in a simple manner. It is additionally possible for the production processes of each individual tubbing to be documented in a simple manner. As a result thereof, in the context of each individual tubbing produced, it is possible for the production of said tubbing to be tracked and thus simultaneously also the production process to be subsequently verified in the assembled tunnel.

A further teaching of the invention provides that the tool is a torque driver, a brush, a roller, a measurement verification element, a nozzle, a scanner, a gripper, or a camera.

A further teaching of the invention provides that the at least one workstation is a station for opening and closing the formwork or a cover of the formwork, a station for retrieving the concrete tubbing a station for cleaning the formwork, a station for preparing the formwork for subsequently introducing concrete, a station for equipping the formwork with elements of the concrete tubbing, a station for verifying the measurements of the formwork, a station for filling the formwork with concrete, and/or a station for treating the surface of the introduced concrete of the concrete tubbing.

A further teaching of the invention provides that the replaceable tool is retrieved from or deposited in a storage space which is displaceable by the robot or situated on the workstation.

A further teaching of the invention provides that an operating step is opening or closing the formwork or the cover of the formwork, retrieving the concrete tubbing, cleaning the formwork, preparing the formwork for subsequently introducing concrete, equipping the formwork with at least one element of the concrete tubbing, verifying the measurements of the formwork, filling the formwork with concrete or treating the surface of the introduced concrete of the concrete tubbing. It is advantageous here for the at least one element to be a seal, a protective liner, a reinforcement element, a sensor, in particular a temperature sensor, a dewatering element, a plastic element, and/or an erector anchor.

A further teaching of the invention provides that the tool is a torque driver, a brush, a roller, a measurement verification element, a nozzle, a scanner, a gripper, or a camera.

The object is furthermore achieved by a control of the method described above, in particular in conjunction with a production plant described above, in which operating steps are implemented at workstations in that data and/or sensor data is evaluated, a robot based on the data and/or sensor data is positioned at an X/Y-position along a production line, a tool based on the data and/or sensor data is selected for carrying out the operating step, and the operating step is carried out by transferring control data to the robot and/or the tool. As a result thereof it is possible for the quality of the production of tubbings to be enhanced in a simple manner. At the same time, the material input in the production of tubbings can be detected and evaluated in a simple manner. It is additionally possible for the production processes of each individual tubbing to be documented in a simple manner.

The object is furthermore achieved by formwork for producing a concrete tubbing of a tunnel lining system, preferably for use in a production plant described above, or when carrying out a method described above, having a concrete tray for receiving a quantity of concrete required for producing the tubbing, and if required for receiving the provided reinforcement of the concrete tubbing, wherein the concrete tray has at least one floor and walls which on the floor are adapted to the shape, wherein at least one wall is releasable from the floor and disposed so as to be pivotable in relation to the floor between a closed position and an opened position, wherein the formwork has at least one drive system for pivoting the at least one wall between the open and the closed position and for retaining said wall in the respective position, and that the drive system has at least one actuator for pivoting the at least one wall between the open and the closed position.

As a result thereof it is possible for the opening and closing to be simplified in a simple manner and to ensure at the same time that the position is retained in a simple manner, so that the formwork remains securely closed.

A further teaching of the invention provides that at least two walls at one of the two external end regions of said walls contact one another by way of the short sides of said walls in the closed position, hereby configuring a corner of the concrete tray. It is advantageous here for a male engagement element to be provided in the external end region on one of the two walls, and for a female engagement element to be provided in the external end region on the other wall, said engagement elements in the closed position of the two walls engaging in one another. As a result thereof, the closure of the corner can be ensured in a simple manner.

It is furthermore advantageous here for the two walls in the external end regions thereof to be connected to one another by means of at least one screw connection or a clamping connection, wherein the screw connection or the clamping connection preferably serves for securing the position, and/or wherein the screw connection has a screw having a spring element which is disposed along at least part of the screw. Said spring element represents in particular a simple additional securing feature by way of which the positioning is guaranteed in a simple manner.

A further teaching of the invention provides that the clamping connection has a locking element which is disposed on one of the wall elements and, by at least one actuator, for example a hydraulic cylinder or a spindle system, is pivotably movable between an open position and a closed position. It is advantageous here for the actuator to be connected to the drive system described hereunder. As a result thereof, a securing feature can be provided in a simple manner.

A further teaching of the invention provides that the at least one wall for moving between the open position and the closed position is connected to at least two actuators of the drive system. As a result thereof, the required retaining forces can be applied and distributed in a simple manner.

A further teaching of the invention provides that the at least one wall element has two external end regions and that at least one actuator for moving and retaining the wall element is provided per end region. It has been demonstrated that a tight closure can be guaranteed in a particularly simple manner as a result thereof, even during filling of the formwork with concrete and any potential deformation of the lateral walls.

A further teaching of the invention provides that the drive system at a workstation for driving the drive system is able to be connected to an external drive. The construction of the formwork can consequently be as simple as possible as a result thereof because a drive in the formwork can be dispensed with.

A further teaching of the invention provides that the drive system is a hydraulic system having at least one hydraulic circuit, wherein the drive system as an actuator has at least one hydraulic cylinder which is connected to the hydraulic circuit. The moving action as well as the retaining action can be provided in a simple manner by way of adequate forces as a result thereof.

It is advantageous here for the hydraulic circuit to have a blocking element for maintaining the pressure in the hydraulic circuit, said blocking element preferably being a load-bearing valve. It is furthermore advantageous here for the hydraulic circuit to have an element for equalizing a variation in terms of pressure and/or a variation in terms of volume in the hydraulic circuit, this preferably being a dummy cylinder or a diaphragm accumulator. It is furthermore advantageous here for the hydraulic circuit to have at least one connector element for releasably connecting the hydraulic circuit to a hydraulic apparatus as the external drive of the drive system at a workstation. It is furthermore advantageously provided that the individual hydraulic cylinders are connected by means of pressure sequence valves. Sequential controlling of the individual steps of opening and/or closing the formwork can be achieved in a simple manner as a result thereof. A hydraulic circuit according to the invention can be provided in a simple manner by at least one of the previously mentioned elements.

A further teaching of the invention provides that the drive system as an actuator is a mechanical drive, preferably a spindle drive. It is advantageous here for the mechanical drive to be conceived so as to be self-locking, or to be provided with a locking element. It is furthermore advantageous here for the mechanical drive to have a connection element for releasably connecting to an external rotational drive, for example a torque driver, as the external drive of the drive system at a workstation.

A further teaching of the invention provides that at least one is cover element is provided so as to be pivotable on the formwork, said cover element being able to be disposed on the upper side of the concrete tray and on the latter at least partially covers the upper side. It is advantageous here for the cover element by at least one actuator, for example a hydraulic cylinder or a spindle system, to be pivotable between an open position and a closed position, said actuator preferably retaining the cover element in the respective position. It is furthermore advantageous here for the actuator to be connected with the previously described drive system.

A further teaching of the invention provides that the cover element has an arrestor element which arrests the cover element in the closed position in relation to the formwork. The invention will be explained in more detail hereunder by means of exemplary embodiments in conjunction with a drawing, in which:

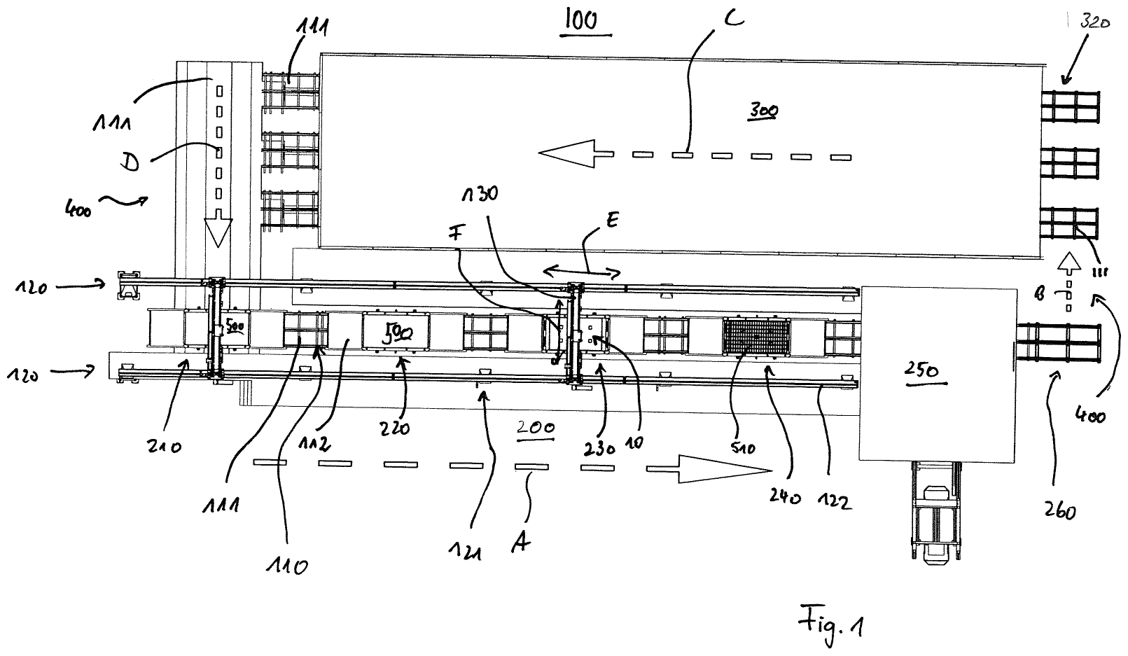

FIG. 1 shows a plan view of a first embodiment of a production plant according to the invention;

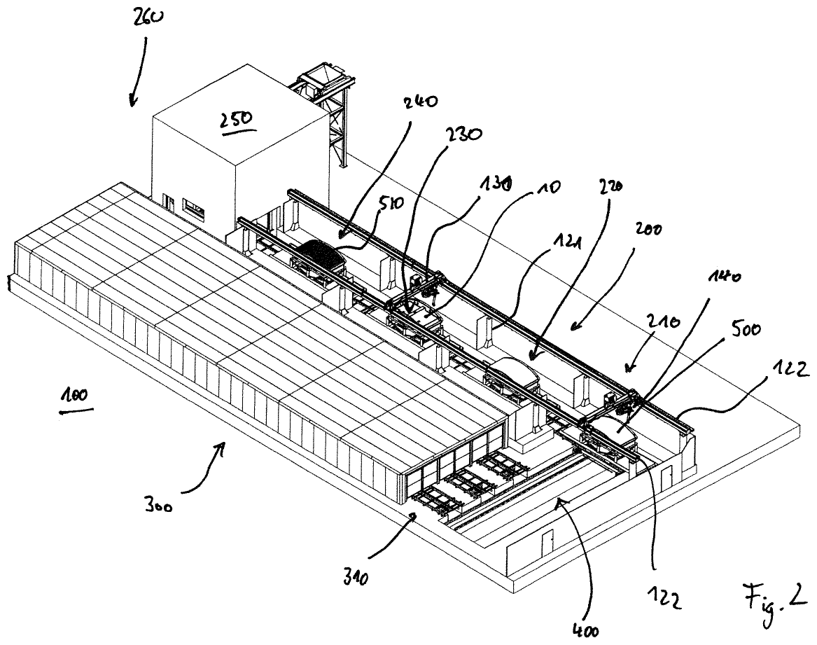

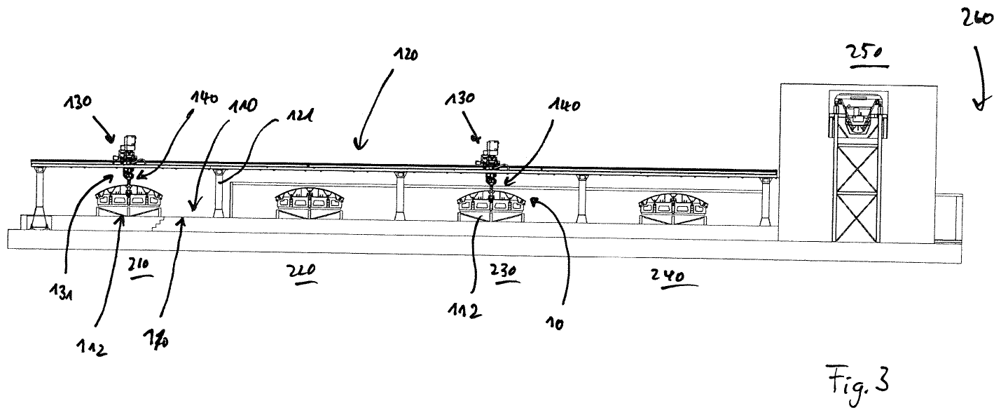

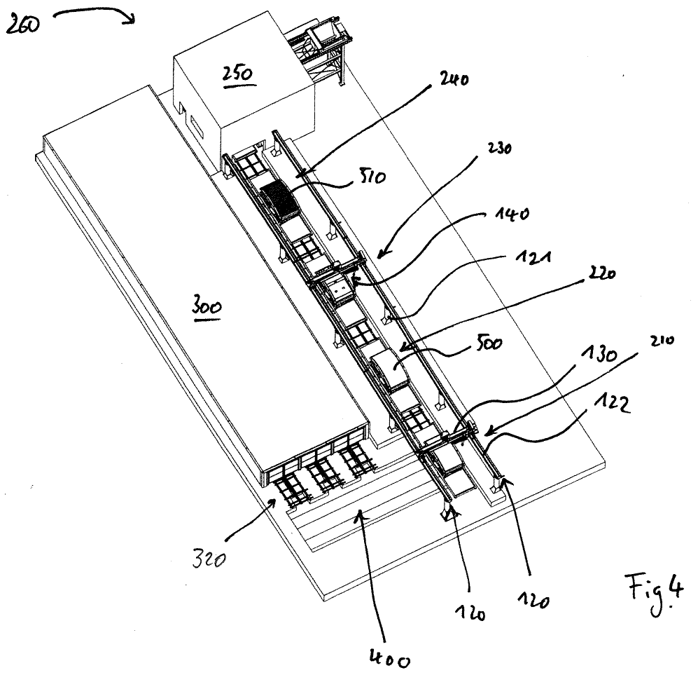

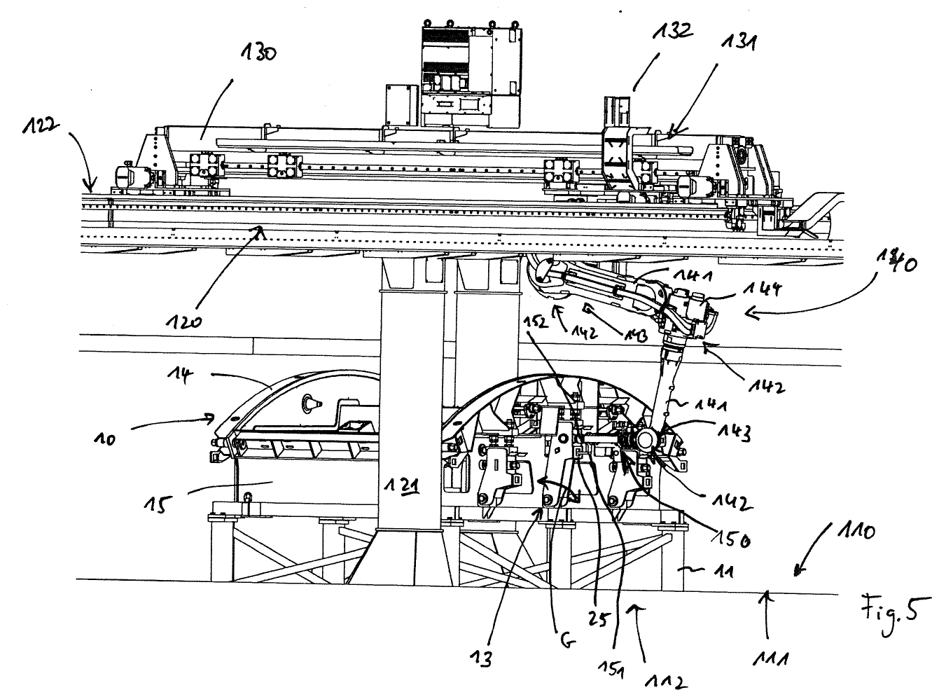

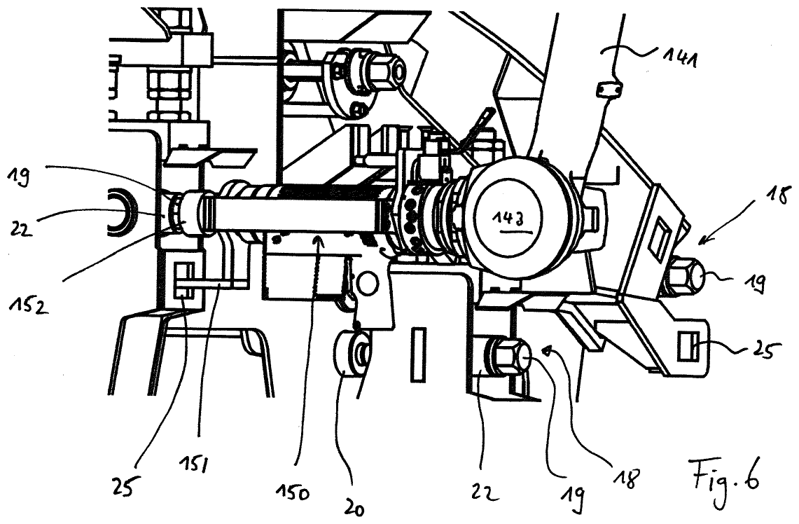

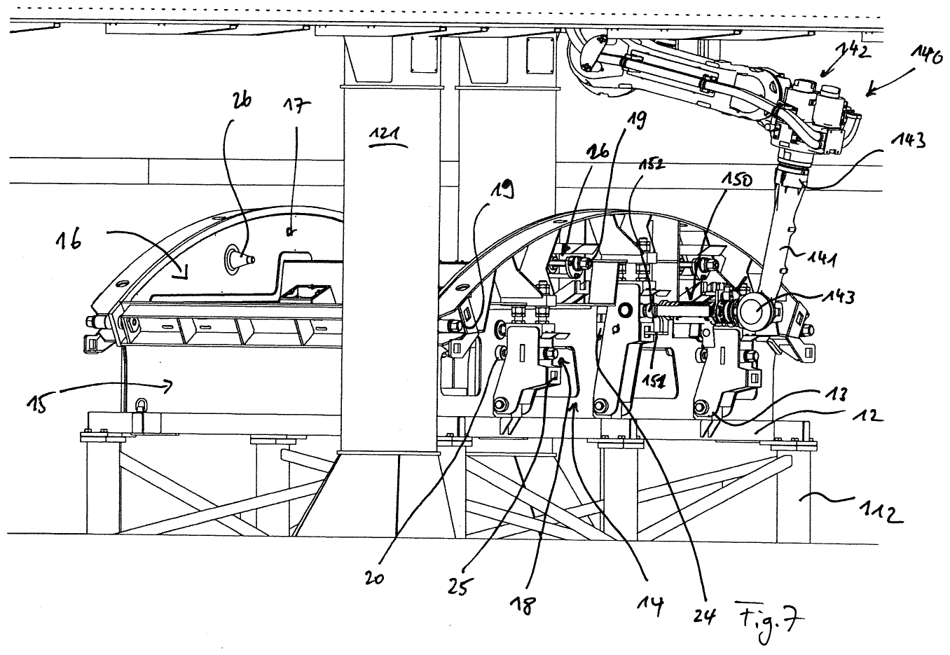

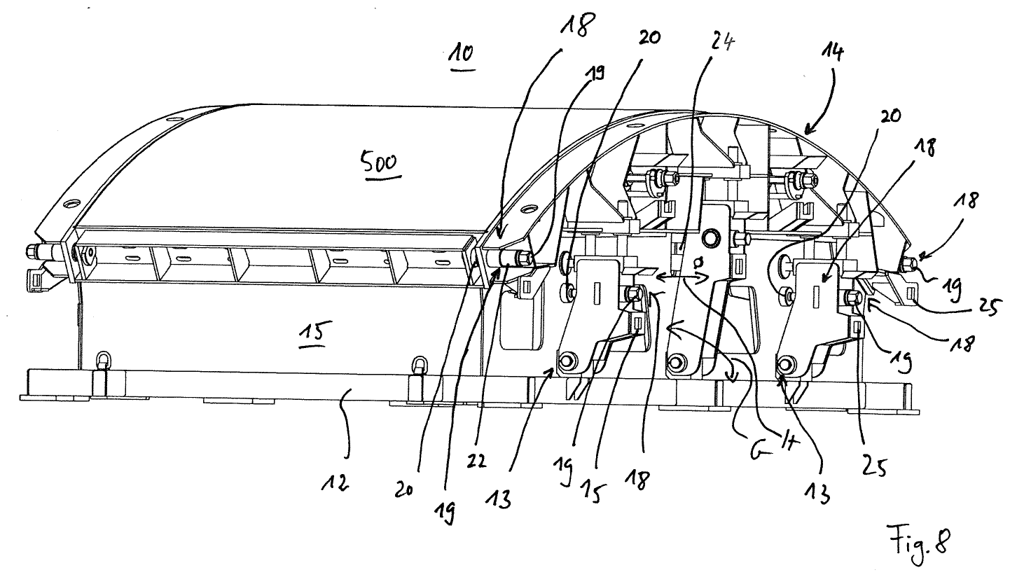

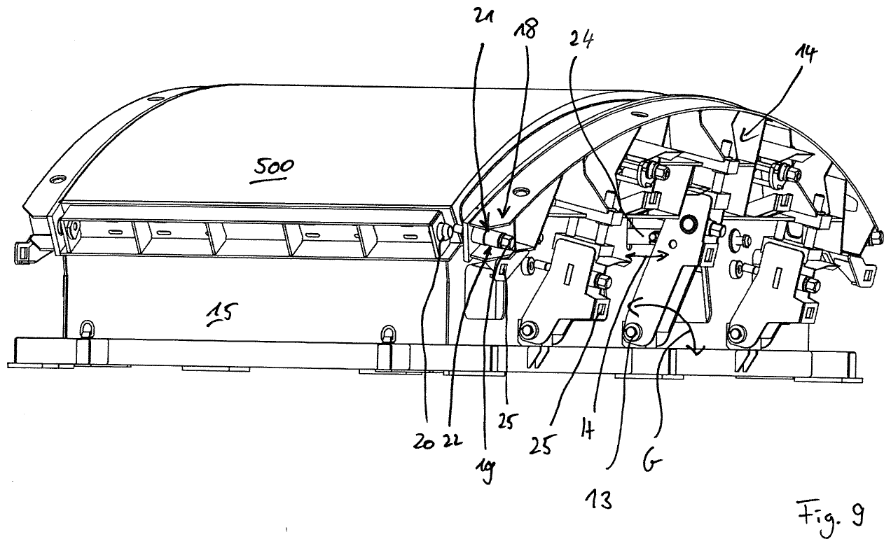

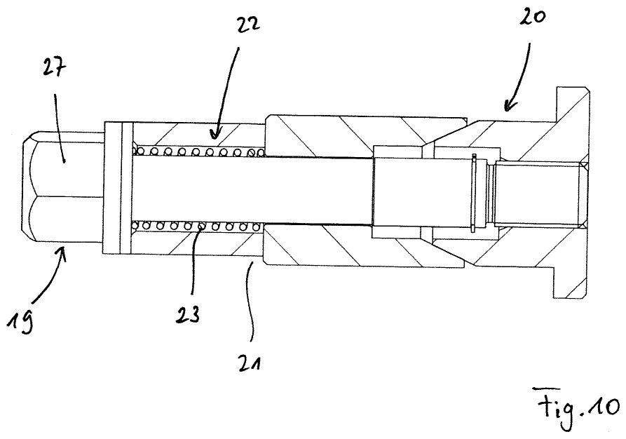

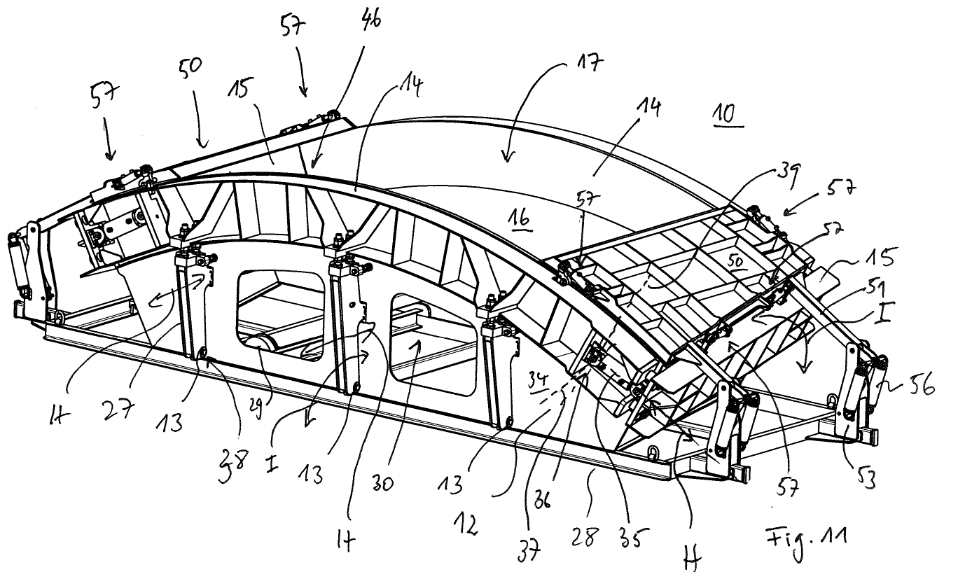

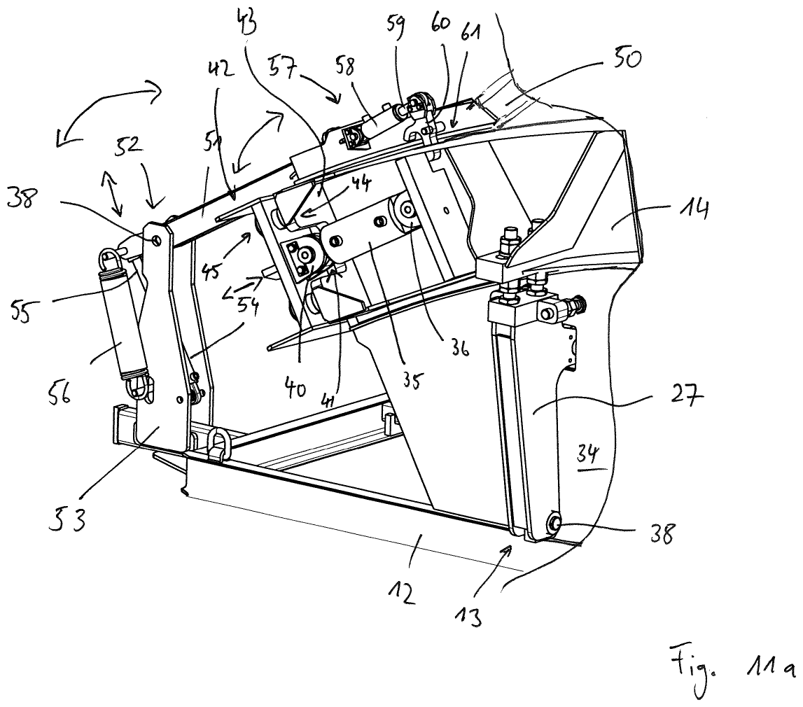

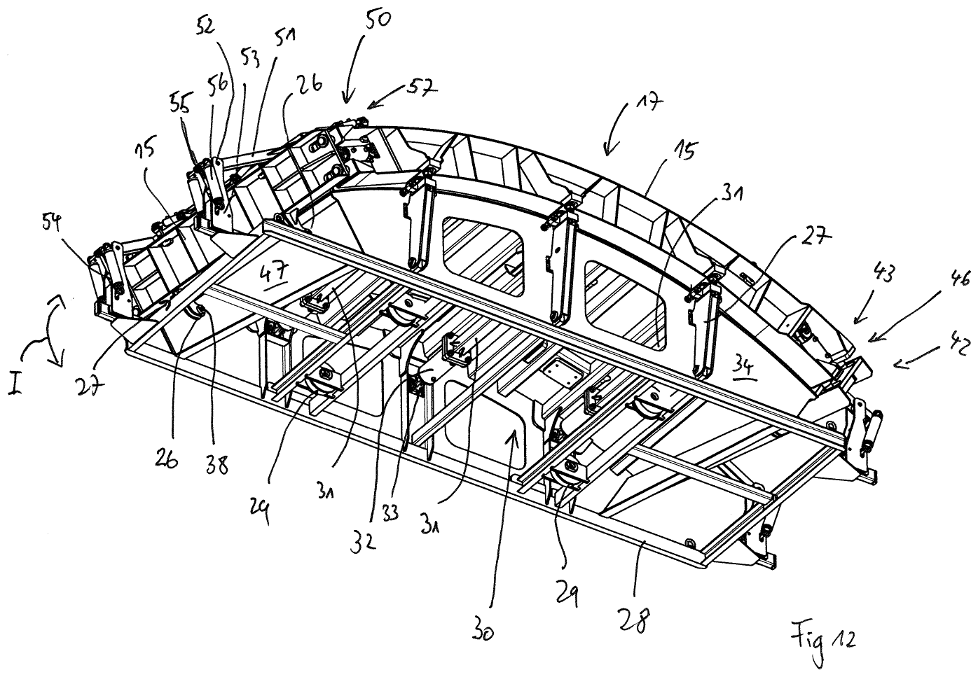

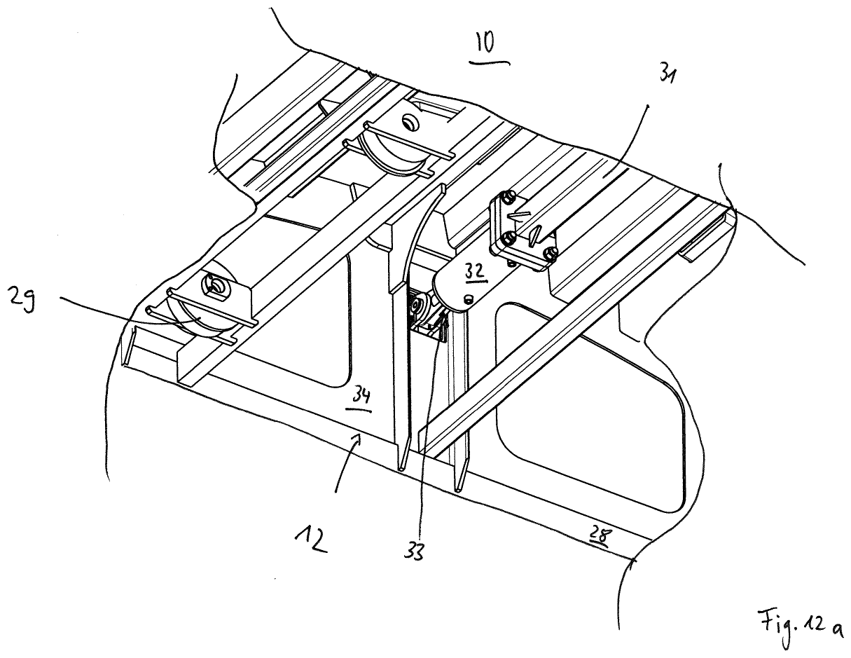

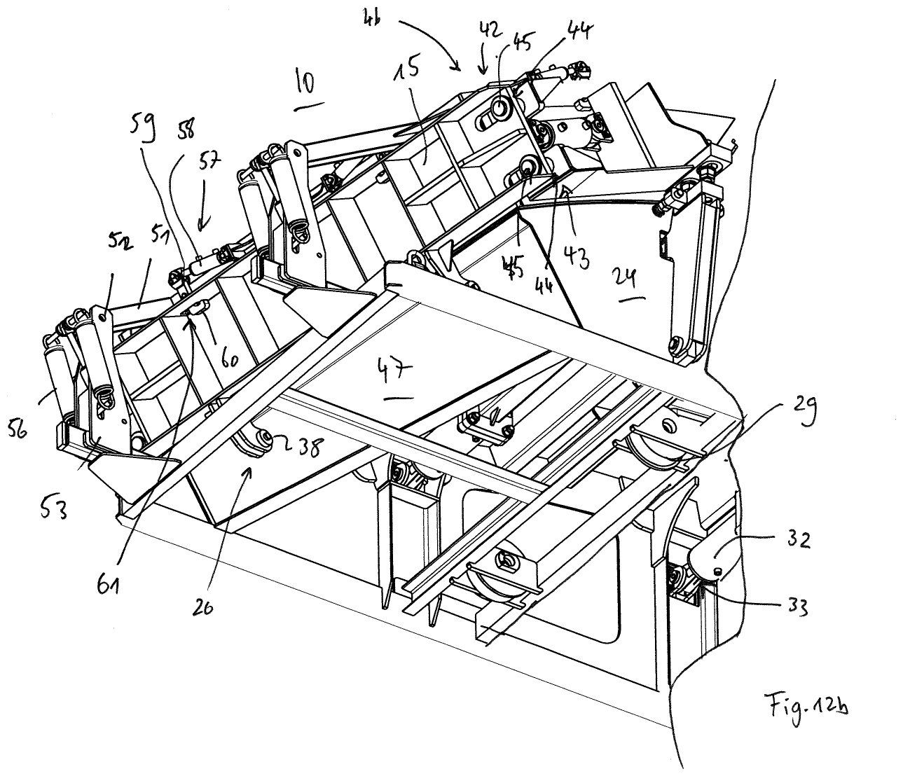

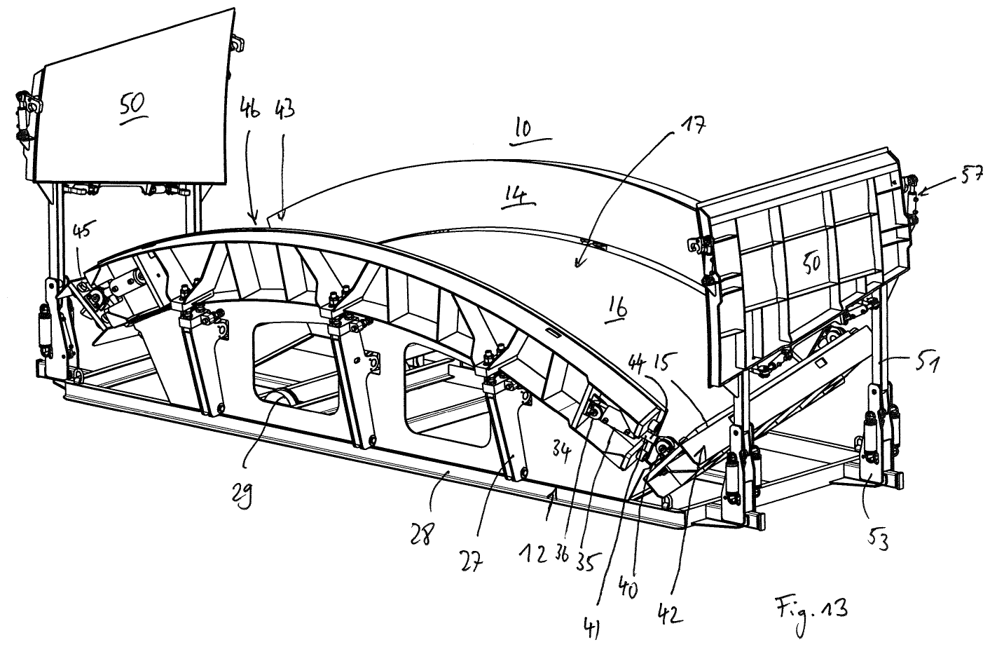

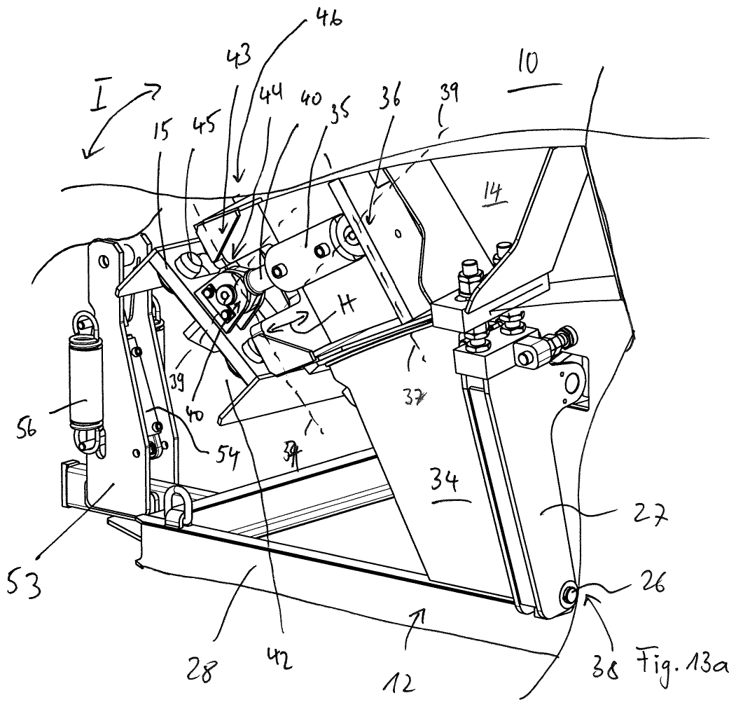

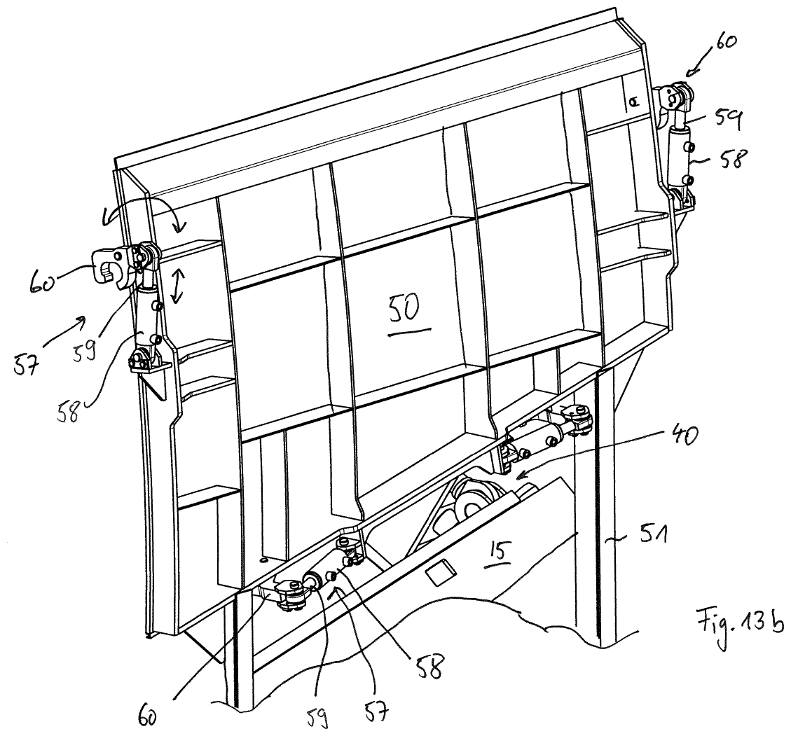

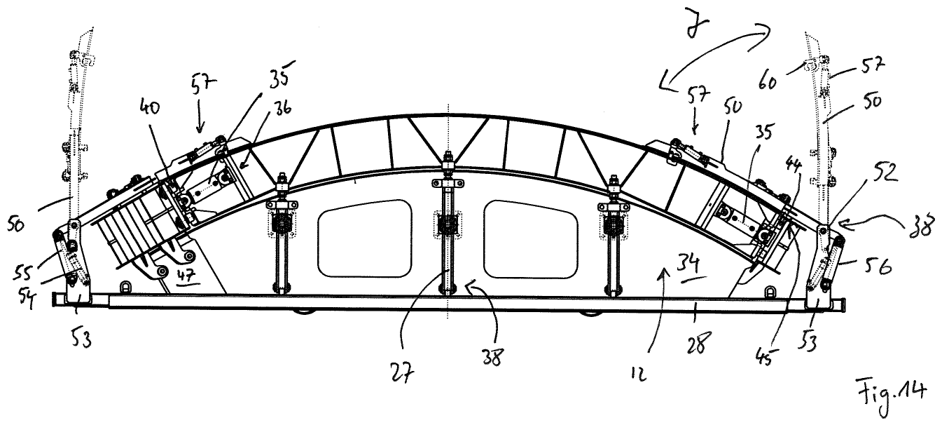

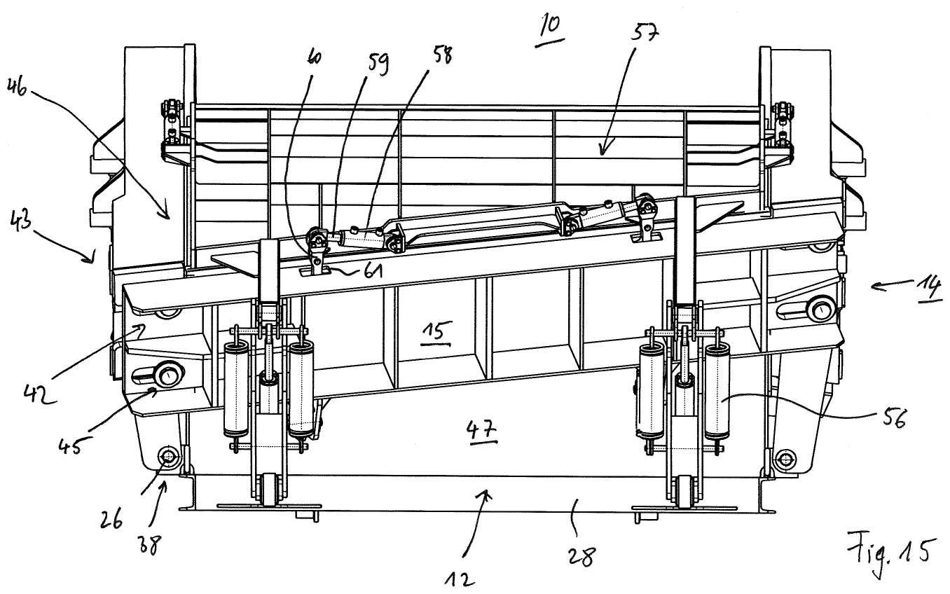

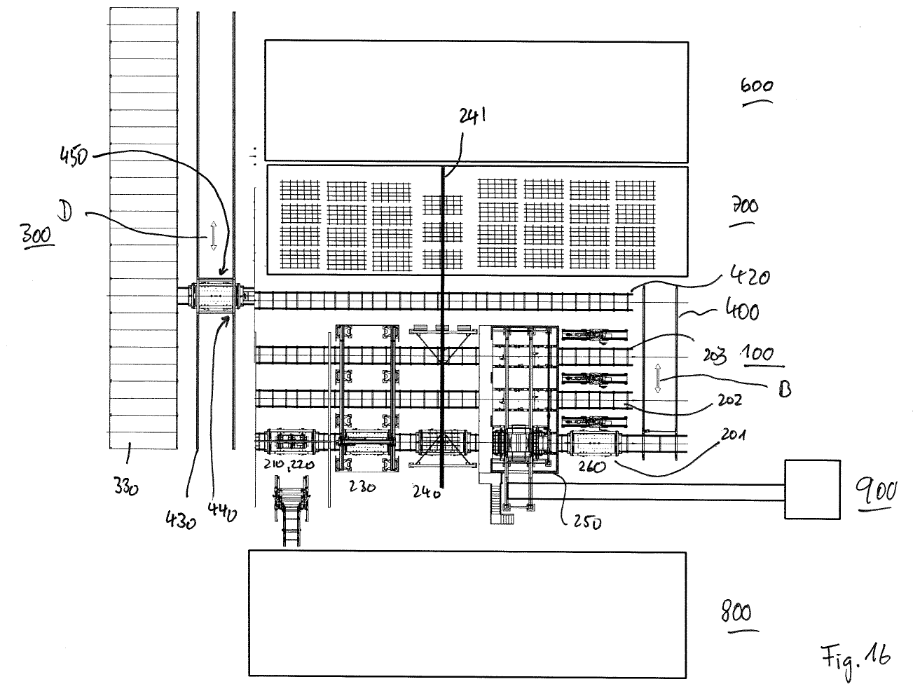

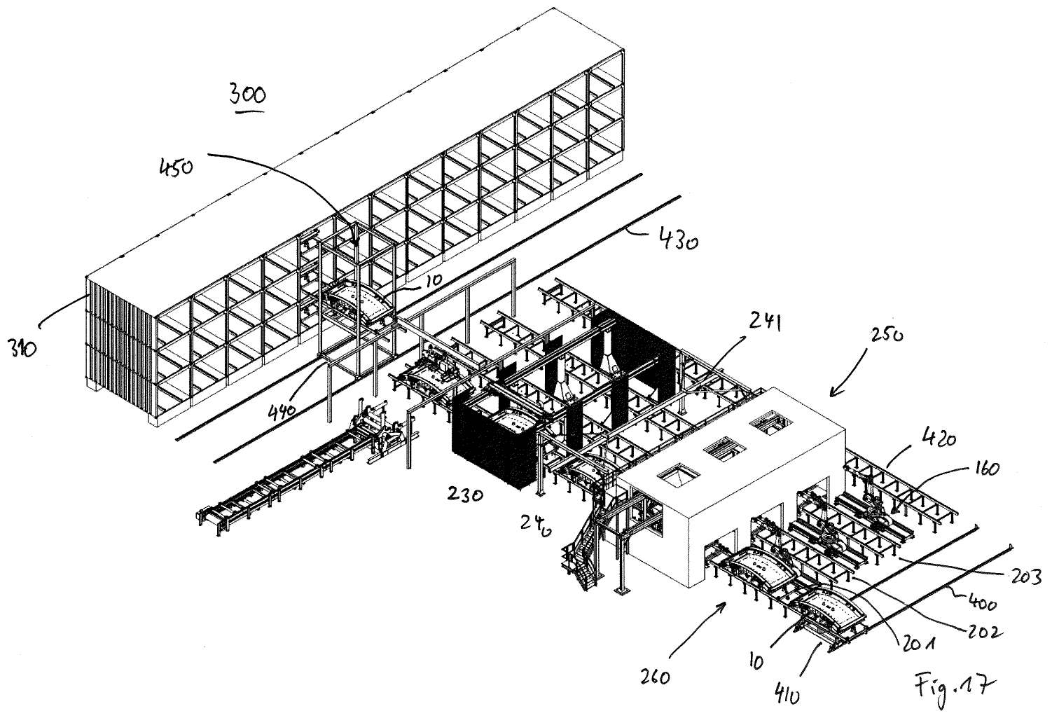

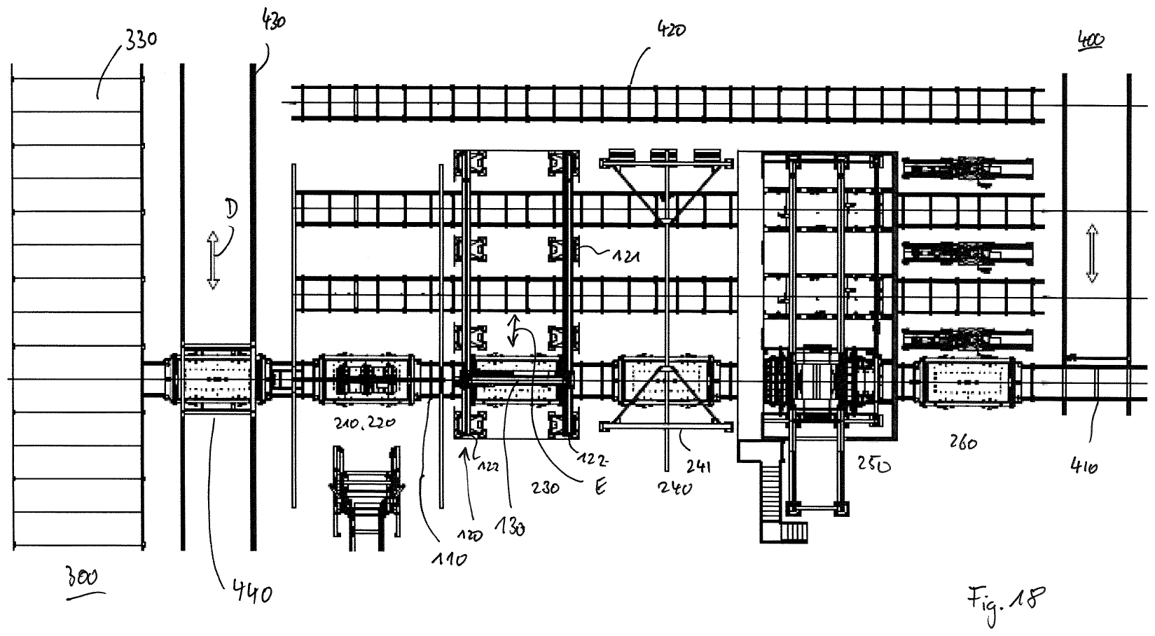

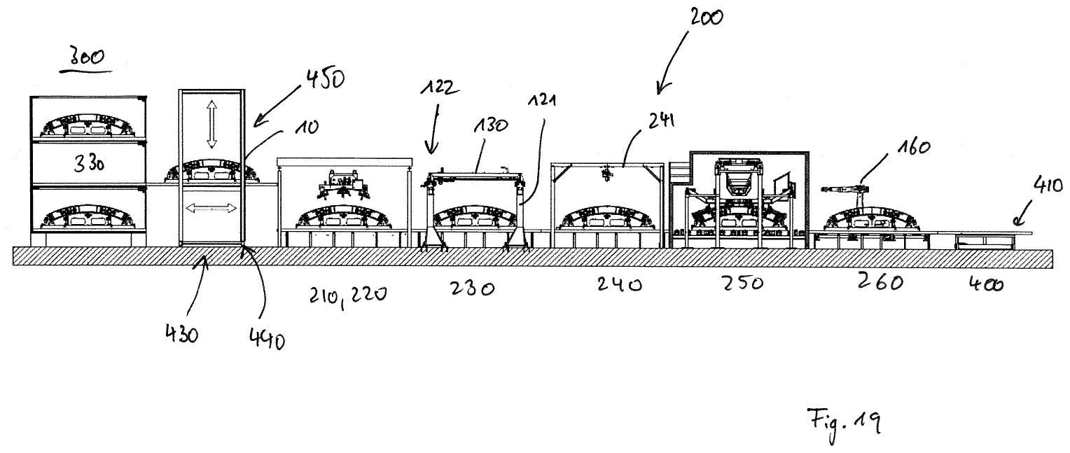

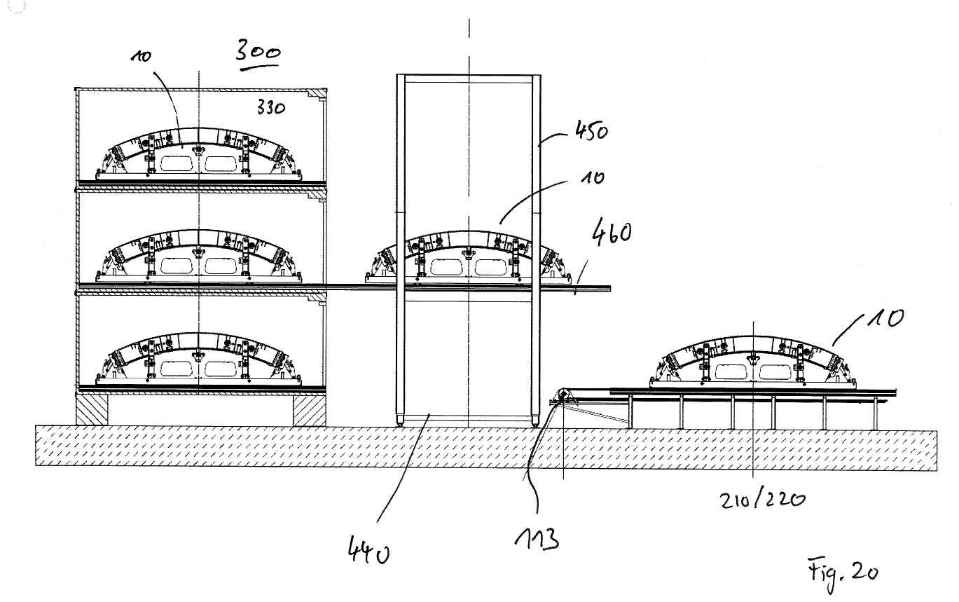

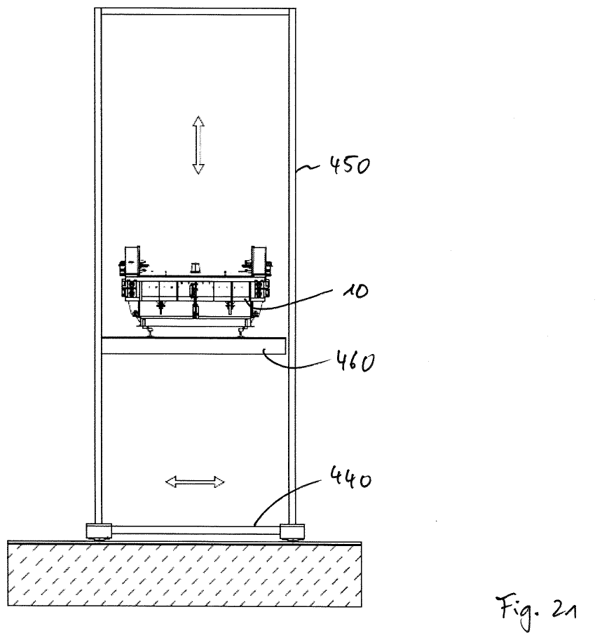

FIG. 2 shows an isometric view of FIG. 1;

FIG. 3 shows a lateral view of FIG. 1;

FIG. 4 shows a further isometric view of FIG. 1;

FIG. 5 shows an isometric enlargement of a fragment of FIG. 3;

FIG. 6 shows an isometric enlargement of a fragment of FIG. 5;

FIG. 7 shows an isometric view of a first embodiment of formwork according to the invention;

FIG. 8 shows an enlarged view of a fragment of FIG. 7;

FIG. 9 shows an isometric view of an opened formwork according to the invention;

FIG. 10 shows a sectional view through a fastening element of FIG. 7;

FIG. 11 shows an isometric view of a second embodiment of formwork according to the invention in a closed state;

FIG. 11a shows an enlarged view of a fragment of FIG. 11;

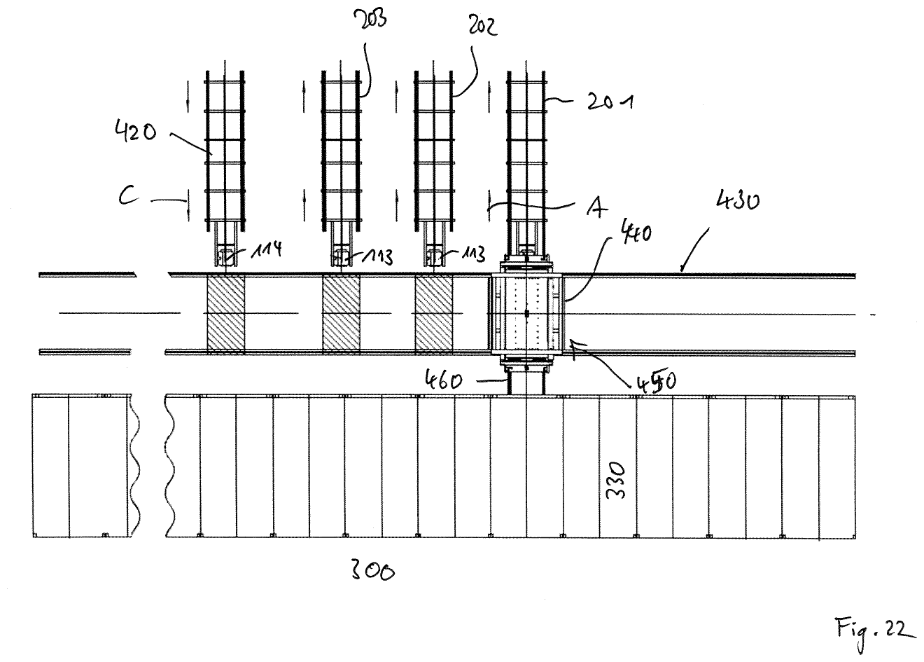

FIG. 12 shows a lower view of FIG. 11;

FIG. 12a shows an enlarged view of a fragment of FIG. 12;

FIG. 12b shows a further enlarged view of a fragment of FIG. 12;

FIG. 13 shows an isometric view of a second embodiment of formwork according to the invention in an opened state;

FIG. 13a shows an enlarged view of a fragment of FIG. 13;

FIG. 13b shows a further enlarged view of a fragment of FIG.13;

FIG. 14 shows an isometric lateral view of the lateral wall of the formwork according to the invention of FIGS. 11 and 13;

FIG. 15 shows an isometric lateral view of the end wall of the formwork according to the invention;

FIG.16 shows a plan view of a second embodiment of a production plant according to the invention;

FIG. 17 shows an isometric view of FIG. 16;

FIG. 18 shows a plan view of FIG. 16;

FIG. 19 shows a lateral view of FIG. 16;

FIG. 20 shows a partial sectional enlarged lateral view of FIG. 19;

FIG. 21 shows a further lateral view of FIG. 20;

FIG. 22 shows a plan view of FIG. 20;

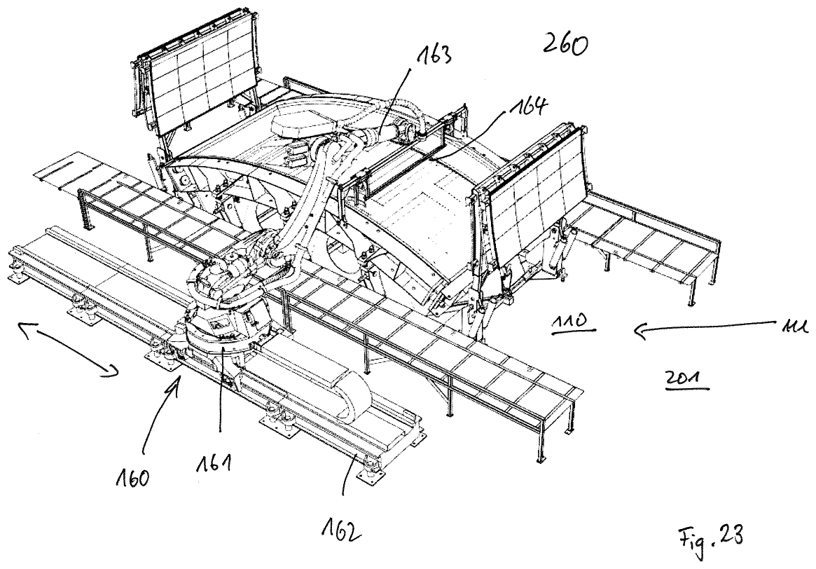

FIG. 23 shows an isometric view of a processing station according to the invention of FIG. 11;

FIG. 24 shows a plan view of a third embodiment of a production plant according to the invention;

FIG. 25 shows an isometric view of FIG. 24; and

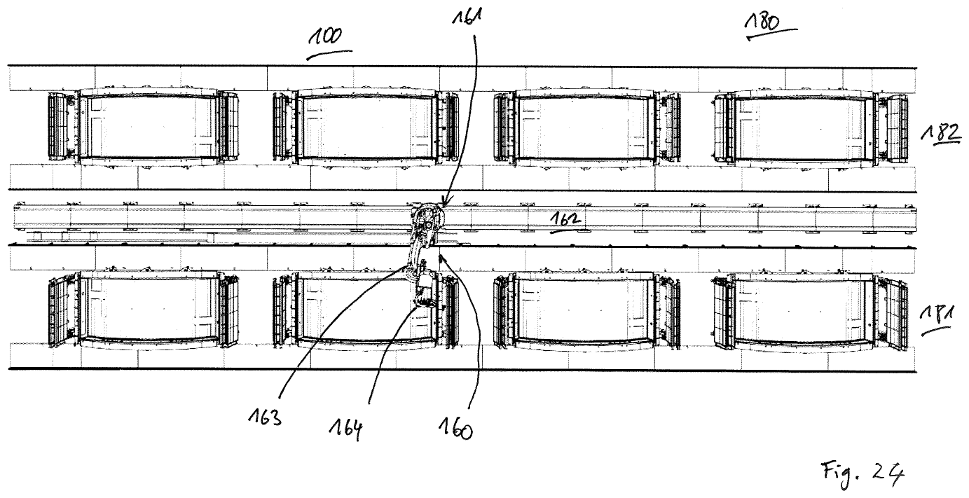

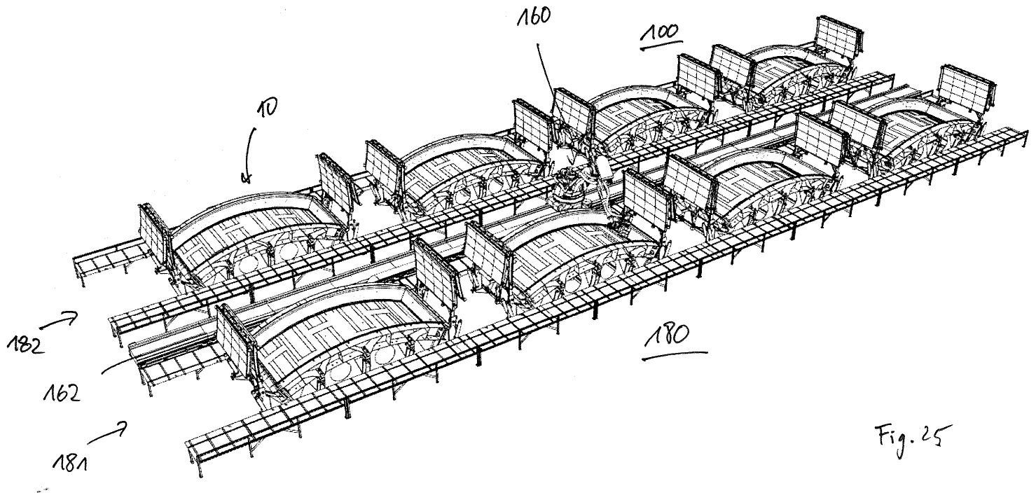

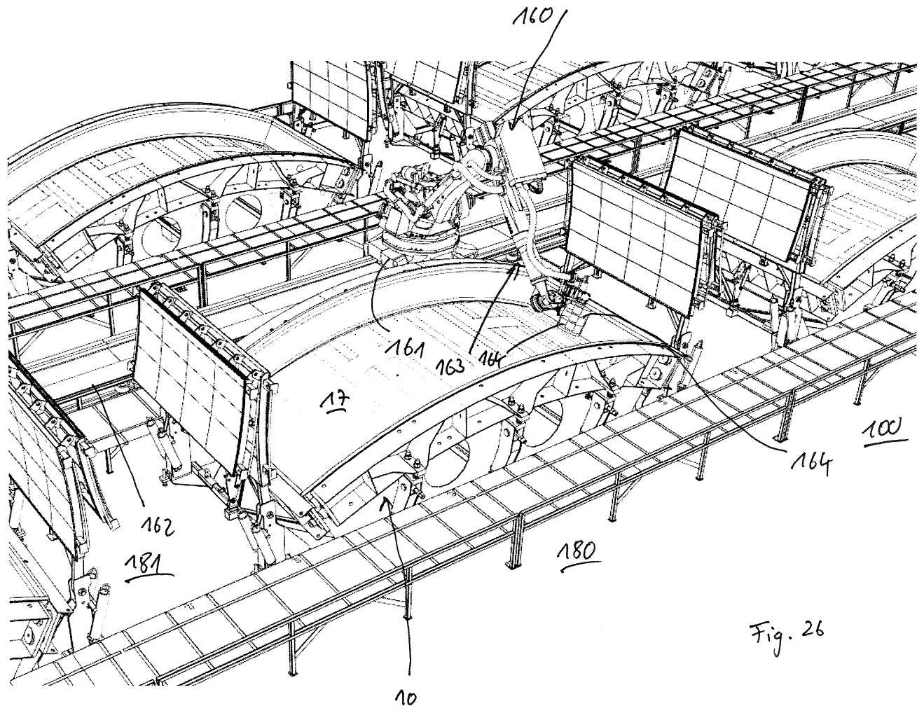

FIG. 26 shows an enlarged view of a fragment of FIG. 25.

FIGS. 1 to 4 show a first embodiment of a production plant 100 according to the invention. The production plant 100 here is embodied as a carousel plant, for example. The carousel plant here is composed of a production line 200 and a curing tunnel 300. The curing tunnel 300 here has at least one curing line 320, whereby three curing lines 320 are illustrated in FIG. 1. The production line 200 and the curing tunnel 300, or the curing lines 320 thereof, respectively, are connected by a transverse conveyor 400.

The production plant 100 has a transport route 110. The transport route 110 has a track 111 on which a transport means 112 is displaceable. Formwork 10 according to the invention is disposed on the transport means 112. The transport means 112 move in the direction of the arrow A along the transport route 110 through the production line 200.

Having passed through the production line 200, said transport means 112 by the transverse conveyor 400 are supplied in the direction of the arrow B to the curing lines 320 of the curing tunnel 300. The transverse conveyor 400 also has a track 111 on which the transport means 112 are moved. The same also applies to the curing lines 320 of the curing tunnel 300.

Having passed through the curing tunnel 300 in the direction of the arrow C, the transport means 112 by means of the transverse conveyor 400 are again supplied in the direction of the arrow D to the production line 200. The carousel is then completed.

The production line 200, when viewed in the direction of the arrow A, from the left to the right in FIG. 1, in an exemplary manner here has six workstations 210-260.

At the first workstation 210, the formwork 10 is opened as explained hereunder.

At the second workstation 220, the finished tubbing 500 is retrieved from the formwork 10 by means of a lifting element (not illustrated).

At the third workstation 230, the formwork 10 is cleaned and prepared for receiving installation elements as well as for concreting. To this end, a release agent (formwork oil), for example, is applied to all faces and parts of the formwork which come into contact with the concrete of the tubbing 500 to be produced and are not intended to be a component part of the tubbing 500.

At the fourth workstation 240, the formwork 10 is equipped with the installation components which are a component part of the finished tubbing 500. This here is, for example, a reinforcement 510, erector anchors (not illustrated), a protective liner, or the like.

After the installation parts have been introduced, the latter alternatively also being able to be completely or partially introduced into the formwork 10 at the third workstation 230, after the cleaning and the preparation has been completed, the formwork 10 having the introduced components is checked so as to guarantee that the formwork 10 is correctly assembled and the installation parts of the tubbing 500 are correctly disposed.

The equipping of the formwork 10 with the installation parts can also take place so as to be divided between the workstations 230, 240.

In the fifth workstation 250, unless already preformed prior hereto, the optionally provided covers (not illustrated) of the formwork are assembled, the concrete to be introduced is prepared according to the required mixture and at the required quantity and incorporated into the formwork 10. The introduced concrete is subsequently compacted in a manner known. The introduction and compaction can take place in an alternating manner until the required quantity of concrete has been introduced.

At the sixth workstation 260, the concrete surface 520 of the tubbing is treated, for example smoothed. Any potential covers are removed prior to smoothing.

In this example, the production line 200 will be exited after the sixth workstation 260 in that the transport means 112, having the formwork 10 and the raw tubbing 500 completely produced therein, is transferred to the transverse conveyor 400.

The number of workstations here is to be considered to be purely exemplary. A person skilled in the art is readily able to adapt the number of workstations by combining the latter or by delinking individual operating steps according to the requirements.

Furthermore, the production plant 100 here in an exemplary manner provides operational automation for the first four workstations 210, 220, 230, 240. To this end, a travel route 120 which is provided so as to be elevated on pillars 121 is disposed on both sides of the transport route 110 of the production line 200. The travel route 120 here has in each case one track 122, the latter being provided on both sides of the production line 200. The two tracks 122 are connected to a crossbeam 130 which is displaceable in the direction of the double arrow E on the travel route 120. A base 131 is disposed on the crossbeam 130 so as to be movable in the direction of the double arrow F on the lower side of the crossbeam 130. Moving here in an exemplary manner takes place by way of a drive 132.

A robot 140 is disposed on the base 131. The robot 140 has arms 141, pivot joints 142 and/or rotary joints 143 as well as drives 144. Furthermore, a tool 150 is disposed on that end of the robot 140 that lies opposite the base 131. The tool 150 here is preferably embodied so as to be replaceable such that different tools 150 can be used depending on the operating step to be carried out.

As a consequence of the displacement capability of the crossbeam 130 in the direction of the double arrow E along the travel route 120, as well as of the displacement capability of the base 131 in the direction of the double arrow F along the crossbeam 130, it is possible for the base 131 of the robot 140 to be disposed in the X/Y-direction above the production line 200. As a result of the construction of the robot 140 it is furthermore possible for the tool 150 to be disposed at any arbitrary point (X, Y, Z) in the space of the production line 200 such that work on or in the formwork 10 can be carried out by the respective tool 150 using the robot 140 by way of the tool 150 of the latter.

Depending on the workstations 210-260, the disposal and embodiment of the latter, and the operating steps to be simultaneously carried out therein, it is possible to provide one or else a plurality, illustrated here are two, crossbeams 130 and robots 140 in the production line 200.

The tools 150 here can be kept ready in a toolbox (not illustrated), either directly on the crossbeam 130 or at the respective workstation 210-260, such that the robot 150, the latter having an interchangeable tool connector system (not illustrated), for example, is able to connect to a tool, remove the latter from the respective box, carry out the operating step, place the tool 150 back into the box after the operating step has been completed, and release said tool.

A first embodiment of the formwork 10 (see FIGS. 5 to 10) is disposed above a pedestal 11 of the transport means 112, for example. The formwork per se has a base 12 by way of which said formwork is able to be disposed on the pedestal 11. An interior space 17 as a concrete tray is provided above the base, said interior space 17 being formed by a floor 16 and internal walls of the end walls 15 and lateral walls 14. The installation parts and the concrete are introduced into this concrete tray, or into this interior space 17, respectively.

The base 12 in this embodiment, although not limited thereto, is pivotably connected to two lateral walls 14 of the formwork 10 by way of pivoting connections 13. The formwork 10 furthermore has two end walls 15. In the formworks 10 shown in FIGS. 5 to 10, the end walls 15 are fixedly connected to the base 12. It is likewise possible here for the end walls 15 to be fixedly connected in a pivotable manner to the base 12 by way of articulated connections.

In the embodiment shown in FIGS. 5 to 10, the lateral walls 14 are connected in a retaining manner to the base 12 and the end walls 15 by way of screw connections. Such a screw connection is shown in a sectional illustration in FIG. 10. Said screw connection has a screw 19 which is screwed into a threaded element 20 which is disposed on the base 12 or on the end wall 15, for example. The screw 19 is inserted into a sleeve 21 which on the lateral wall 14 is attached above a through opening (not illustrated), for example. The sleeve 21 here has a spring portion 22 in which a spring 23 is provided.

When the threaded element 20 and the sleeve 21 are disposed so as to be mutually aligned on top of one another, for example when the lateral wall 14 is disposed against the end wall 15 and the base 12, the screw 19 can be screwed into the threaded element 20 and thus arrest the lateral wall 14 in relation to the base 12 and/or the end wall 15.

Provided to this end is a drive system which enables the lateral walls 14 to move in relation to the base 12 and/or the end walls 15, alternatively also the floor 16. This here can be a spindle system as a mechanical drive, for example, that when said spindle system is driven, the lateral walls 14 are moved in the direction of the double arrow G about the pivoting connection 13 either away from the base 12 and the end walls 15 and the floor 16, or toward said base 12 and said end walls 15 and said floor 16. Alternatively, other drive system such as, for example, hydraulic cylinders can also be used to this end. A further exemplary embodiment having a hydraulic drive system will be explained in a second exemplary embodiment according to the invention, but can also be alternatively used in the first exemplary embodiment.

If a mechanical drive system is used, said mechanical drive system can be conceived such that said mechanical drive system is self-locking so that no screw connections are required in order to retain the lateral walls 14 in relation to the floor 16 and the lateral walls 15. Alternatively or additionally, a blocking element (not illustrated) can also be used in order to guarantee a retaining action by preventing a reverse movement of the spindle drive.

In one preferred embodiment, the central spindle can also be driven by a suitable tool, preferably the same tool by way of which the screws 19 are released and tightened. A rod element 24 which is movable in the direction of the double arrow H by the central spindle is shown in FIGS. 7, 8 and 9.

Screwing the screw 19 into the threaded element 20 takes place counter to the spring element 23, the spring element 23 forcing the screw 19 outward when the latter is unscrewed, respectively, such that said screw when being unscrewed moves more easily out of the threaded element 20.

As a result thereof, it is possible in a simple manner when using a torque driver as the tool 150 on the robot 140, for said torque driver to be able to unscrew the screw 19 from the threaded element 20 such that said screw 19 is reliably released without the torque driver having to exert an extraction force on the screw 19.

Furthermore, the formwork 10 in the region of the screws 19 has engagement openings 25 into which a torque absorption element 151 engages so as to relieve the tool 150 creates or so as to relieve the robot 140, which otherwise would have to correspondingly absorb the torque.

Apart from the torque driver, a further tool may be (not exhaustive and enumerated only in an exemplary manner and not illustrated): a brush, a rotatable brush, a nozzle for dispensing air, water or chemicals, a scanner, optical measuring installations, rollers.

A second embodiment of the formwork 10 according to the invention is illustrated in FIGS. 11 to 15.

The formwork 10 has an interior space 17 for receiving the reinforcement, installation parts and concrete for producing the concrete tubbing 500. The latter is formed by a floor 16 as well as the internal sides of the lateral walls 14 and of the end walls 15. The floor 16 here is disposed on a base 12.

The lateral walls 14 and the end walls 15 are fixedly disposed on the base so as to be pivotable by way of a pivoting connection 13, 26. The pivoting connection 13, 26 is in each case connected to the lateral wall 14, or to the end wall 15, by way of one connection element 27. The lateral walls 14 and the end walls 15 are pivoted about a pivot point 28 by way of the connection elements 27 such that the lateral walls 14 and the end walls 15 are released from the floor 16 and are pivoted outward, as is shown in FIG. 13. The pivoting takes place in the direction of the double arrow I.

The base 12 has a lower frame 28 on which inter alia a running gear for example is disposed, the latter here in an exemplary manner having wheels 29. Alternatively, the frame 28 can also be disposed on a transport element 112 so as to be displaced along a production line, or the travel route of the production line per se has rollers on which the formworks 10 are displaceable.

Base elements 31 and actuators 32, the latter here preferably in the form of hydraulic cylinders which are fixedly connected to the base element 31, are provided in an interior space 30 of the base 12. A moving element 33 of the actuator 32, here a piston rod, for example, is connected to the connection element 27. By moving the moving element 33 of the actuator 32 in a linear manner, the connection element 27 is moved from a lateral wall 34 of the base 12 in the direction of the double arrow H. Said connection element 27 is simultaneously rotated about the pivot point 38 such that the lateral wall 14 is moved away from the interior space 17, or the floor 16, respectively, such that the formwork 10 is opened in relation to the lateral walls 14.

At least one actuator 35, here a hydraulic cylinder, for example, is provided for opening the end walls 15, the latter likewise being connected to the base 12 by way of a connection element 27 having a pivoting connection 26 which has a pivot point 38. Said actuator 35, in a manner similar to the previously described actuator 32, can be disposed in conjunction with the base element 31 in the interior space 30. Alternatively, the actuator 35 by way of a connection 36 is disposed on the lateral wall 14. The actuator 35 in the connection 36 is rotatable about a first axis 37 and simultaneously disposed so as to be rotatable about a second axis 39 such that the actuator 35, when the end wall 15 is opened, can be pivoted conjointly with the lateral wall 14 when the latter is opened.

The same applies to the connection 40 by way of which the actuator 35 is connected to the end wall 15. The actuator 35 has a moving element 41, here a piston rod, for example, which can be moved in the direction of the double arrow H out of the actuator 35 so as to pivot the end wall 15 in the direction of the double arrow I about the pivot point 38 in the pivoting connection 26.

A corner 46 of the interior space 17 is formed as a result of an external side 42 of an end wall 15 contacting an external side 43 of the lateral wall 14. Additionally, a male engagement element 44 and a female engagement element 45, which in the closed state of the formwork engage in one another, are provided on the external side 42 of the end wall 15 and in analogous matching manner on the external side 43 of the lateral wall 14. The male engagement element 45 here is preferably disposed on the end wall 15, and the female engagement element 44 is preferably disposed on the lateral wall 14, such that the male engagement element 45 prevents the lateral wall 14 moving in the closed state of the end wall 15. By tightening and retaining the moving element 41 of the actuator 35, the end wall 15 at the external end 42 thereof is pressed onto the lateral wall 14 at the external end 43 of the latter. The male engagement element 45 simultaneously engages in the female engagement element 44 and as a result thereof blocks in addition to the tightening and retaining of the moving element 33 of the actuator 32 such that the lateral wall 14 cannot be released from the floor 16 as long as the end wall 15 bears on the floor 16. By tightening and retaining the moving element 41 of the actuator 35 at the external end 42, preferably in conjunction with the engagement elements 44, 45, opening of the corners 46 is simultaneously effectively and easily avoided, said corners 46 being formed between the lateral walls 14 and the end walls 15.

By distributing the pivoting connections 13, 26 along the lateral walls 34, 47 of the base 12 it is prevented that the lateral walls 14 and the end walls 15 are released from the floor 16, for example as a result of being deformed by the load of the introduced concrete.

The formwork 10 furthermore has two covers 50 which are attached to the base 12 and during the production process of the concrete tubbing 500 are either closed, as is illustrated in FIG. 11, or opened, as is illustrated in FIGS. 13 and 14.

The covers 50 can be pivoted in the direction of the double arrow J between the closed position on the interior space 17 and the open position. Said covers 50 serve for closing the formwork 10, or the interior space 17 thereof, respectively, toward the top when the concrete is filled into the interior space 17. In the production of tubbings, formworks 10 having partial covers, like the covers 50 shown in the second embodiment of the formwork 10 according to the invention here, or else without covers 50 as is the case in an exemplary manner in the first embodiment according to the invention, are known. The regions not covered, prior to filling the formwork 10 with concrete, are closed by a cover, whereby open regions through which the concrete is then filled into the interior space 17 are still present. These additional covers are attached before or in the concreting workstation.

If covers 50 which can be moved between an opened position and a closed position, are provided on the formwork 10, as here in the second exemplary embodiment, said covers 50 are closed in or before the concreting workstation. After concreting, the covers are either removed or opened again in order for the surface 520 of the raw concrete tubbing to be processed in a further operating step/in a corresponding further workstation. After this operating step has been completed, the covers 50 are closed again. The formworks 10 having closed covers 50 are subsequently supplied to the curing station. The covers 50 then remain correspondingly closed within the curing station. Once the curing has been completed, the covers 50 are opened. The lateral walls 14 and the end walls 15 are subsequently also opened in the required sequence. The pre-cured concrete tubbing 500 can be retrieved thereafter.

After the concrete tubbing 500 has been retrieved, the formwork 10 is correspondingly cleaned and prepared for the production of a new concrete tubbing 500, as has been described above. Depending on the possibility of transportation, the lateral walls 14, the end walls 15 and the covers 50 are either closed or remain in the opened state. The covers 50, the end walls 15 and the lateral walls 14 may have to be opened again in the cleaning station in order for complete cleaning to be able to be performed. The lateral walls 14 and the end walls 15 are closed after cleaning. The interior space 17 is then equipped with a corresponding reinforcement and corresponding installation parts. Once this has been completed, the formwork 10 is subsequently prepared for concreting as has been described above.

The covers 50 are provided with connection elements 51 which are connected to the base 12 by way of a pivoting connection 52. The pivoting connection 52 here is disposed so as to be rotatable on a protruding element 53. Provided is an actuator 54 which is connected to the base 12 in parallel with the protruding element 53. The connection element 51 extends beyond the pivoting connection 52. The moving element 55 of the actuator 54 then engages on this part of the connection element 51. By moving the moving element 55 in and out, the cover 50 is pivoted in the direction of the double arrow J about the pivot point 38, the latter being situated in the pivoting connection 52. Spring elements 56 are provided as facilitation in order to guarantee better opening and closing, or a better pivoting movement in the direction of the arrow J, respectively.

The actuator 54 here is preferably a hydraulic cylinder. The moving element 55 here represents the piston rod of the hydraulic cylinder. The actuator 54, apart from opening and closing, also has the effect of retaining the cover 50 in the respective position.

Additionally provided for securing on the cover 50 are securing elements 57 which are provided with an actuator 58 which has a moving element 59. The moving element 59 is connected to a blocking element 60 which by moving the moving element 59 in and out is movable, here preferably pivotable, between a locking position and a free position. Engagement openings 61 in which the blocking element 60 engages for locking are provided for locking on the lateral walls 14 and the end walls 15, respectively. The locking takes place during the curing, for example.

In order to control the actuators of the formwork 10, when said actuators are embodied as hydraulic cylinders, said actuators are part of a hydraulic circuit. The actuators hereunder are described as hydraulic cylinders. The hydraulic cylinders 32 for opening and closing the lateral walls, and the hydraulic cylinders 35 for opening and closing the end walls, here are provided such that the walls close when the hydraulic cylinder moves inward. The hydraulic cylinders 54 of the cover 50, and the hydraulic cylinders 58 for activating the blocking element 60, here are disposed such that the cover 50 and the blocking element 60 close when the hydraulic cylinder moves inward.

The hydraulic circuit at those respective workstations where the hydraulic cylinders have to be activated is connected to a hydraulic apparatus, not illustrated, by way of a connector. The application of the retaining force of the hydraulic cylinders after the lateral walls 14 and the end walls 15 have been closed, and after the covers 50 and the blocking element 60 have been closed, has to be maintained once the hydraulic circuit of the formwork 10 has been decoupled from the drive apparatus.

Maintaining the required closure forces takes place by non-return valves (not illustrated) which are introduced into the hydraulic circuit. The non-return valves have the effect that the hydraulic liquid introduced into the hydraulic cylinder cannot return from the latter once the hydraulic apparatus no longer impinges the hydraulic circuit with hydraulic fluid, as a result of which the pressure on the piston face of the hydraulic cylinder remains constant.

In order for variations in terms of pressure/variations in terms of volume in the hydraulic circuit, for example by virtue of variations in temperature in the curing plant, to be counteracted, compensation elements are provided at corresponding locations in the hydraulic circuit. These here can be, for example, diaphragm accumulators or dummy cylinders.

The required control sequence here results from which cylinders have to be first impinged with hydraulic liquid. Switchable blocking elements can be provided between the individual cylinders for sequencing the control of the individual movements. These here are preferably pressure sequence valves.

The method according to the invention will be explained in more detail in an exemplary manner hereunder by means of the preferred exemplary embodiment shown.

At the first workstation 210, the formwork 10 by way of the transport means 112 is supplied from the transverse conveyor 400 into the production line 200. The pre-cured tubbing 500 is in the formwork 10 at this point in time. The formwork 10 is closed; the lateral walls 14 and/or the end walls 15 are connected to one another by screw connections. At this point in time, the cover elements (not illustrated) can be additionally provided in the closed position.

The formwork 10 is disposed in the exact position at the first workstation 210. The formwork and/or the tubbing is preferably simultaneously scanned and detected. To this end, labels or RFID chips are evaluated using the suitable tools, for example. The data determined is input into a data processing system.

Simultaneously, the required operating step is selected based on this data, for example by a memory-programmable controller, and the corresponding control commands are transmitted to the robot 140 in order for the corresponding tool required to this end to be selected and the operating step to be carried out.

At the first workstation 210 here, this would be, for example, to the extent required, unscrewing the covers, or the opening of the latter by releasing screw connections or clamping connections; removing the concrete installation parts 26, in particular by unscrewing; releasing the corner connections between the end walls 15 and the lateral walls 14, for example by releasing the screw connection 18 in that the screw 19 is unscrewed by means of the tool 150, in this instance here a torque driver, or releasing a clamping connection; opening the end walls 15 and/or the lateral walls 14, for example by pivoting about the pivot in connection 13, for example by a drive such as a central spindle or hydraulic cylinders.

After the operating step has been completed, a scanning procedure can be carried out so as to verify whether the operating step has been adequately carried out and completed, for example in that the measurements of mutual spacings of the lateral walls 14 and/or the end walls 15 are verified.

The corresponding data determined here is transmitted to the data processing system again, for example, this system, when corresponding parameters have been adhered to, upon checking the latter clearing a release for the onward transportation to the next workstation.

The formwork in the completed state, for example after the workstation 210, is opened.

The retrieval of the tubbing 500 from the formwork 10 could already take place at the first workstation 210, optionally in a manner incorporated in the control system and also actuated by the latter. To this end, a crane (not illustrated) having a corresponding lifting unit (not illustrated) could be provided in order for the tubbing 500 to be retrieved from the formwork 10.

Alternatively, this step takes place at the second workstation 220, as is provided here. After the positionally accurate transfer which between all workstations is performed also by way of the data system in conjunction with the memory-programmable controller, for example, the formwork 10 is situated so as to be in the exact position at the second workstation 220. Here too, the formwork and/or the tubbing 500 is again correspondingly identified and detected. As has already been described above, the pre-cured tubbing 500 here in an exemplary manner is now correspondingly retrieved from the formwork 10 so as to initiate the further steps such as, for example, moving the pre-cured tubbing 500 to a curing store.

Subsequently, corresponding checking can again take place. This data also is again transferred to the data system. After checking and clearance, the formwork 10, still present as an opened formwork here, is then transported to the third workstation 230. At this point in time, the formwork 10 is empty, opened and not cleaned.

The formwork 10 is introduced in the exact position at the third workstation 230 as well. In addition, the formwork 10 can in turn be recognized here correspondingly. The determination of the state of the formwork 10 can optionally also be carried out at this point in time, in particular in terms of the positions and unfolding angles of the individual walls 14, 15.

Based on this data, the memory-programmable controller transmits the corresponding items of information and operating instructions to the robot 140.

The crossbeam 130 and/or the base 131 of the robot 140 are moved to the respective required target points. Furthermore, the robot 140 is equipped with the corresponding tool 150, for example in that the robot 140 connects to the corresponding tool 140 and retrieves the latter at a storage location.

The corresponding operating step is then carried out, wherein movements of the crossbeam, of the base as well as of the component parts of the robot 140 may be superimposed in order for the corresponding operating step to be carried out. Unless otherwise required, aforementioned movements for optimization here may be dispensed with.

At the third workstation 230, corresponding cleaning of the opened formwork 10 and preparing the surfaces of the formwork 10 that later are in contact with concrete, such as the floor 16, the internal faces of the lateral walls 14 and the end walls 15 as well as of the concrete installation parts 26, for example, is carried out by applying a release agent such as, for example, formwork oil.

To this end, a high-pressure nozzle for jet-cleaning or blowing out the formwork parts and/or a brush for cleaning are/is selected as a tool, for example. The sequence here is to be selected according to the requirements.

Additionally, blowing out the mold parts can also be performed with compressed air by way of a nozzle, for example.

The same applies to a potentially present cover, and in particular also to clearances into which installation parts such as seals, erector anchors, or other plastic parts are later inserted.

Once the cleaning has been completed, a scanning procedure can again be carried out in order to correspondingly check the quality of cleaning.

An optical tool is selected to this end, for example, said optical tool determining the degree of cleaning by means of reflections or the like. The corresponding data is again transferred to the data processing system and the controller.

The incorporation of the release agent into the formwork then subsequently takes place again using a correspondingly suitable tool such as, for example a nozzle, this optionally being followed by renewed checking.

Alternatively, the formwork can also be closed prior to the release agent being introduced. To this end, the end walls 15 and/or the lateral walls 14 in the present embodiment are correspondingly moved to a closure position by way of a drive, here a central spindle which is driven by the torque driver, for example. The screw connections 18 are subsequently joined by screws, for example in that a corresponding socket 152 is placed onto the head 27 of the screw 19 and the latter is then screwed into the threaded element 20 counter to the spring element 23.

Once the screwing procedures have been completed, checking of the primary state can again be carried out by means of a scanning unit. Alternatively, it is also possible for the step of cleaning and preparing and the step for closing the formwork 10 to be divided among the workstations.

Once the operating steps at the third workstation 230 have been completed, the formwork 10 is clean, the corresponding release agent has been applied, and the formwork is correspondingly closed.

Additionally, the concrete installation parts 26 may also have been moved into the interior space 17 of the formwork 10, for example in that said concrete installation parts 26 have been moved by being screwed by way of the torque driver as the tool 150.

The clearance for moving the formwork 10 to the fourth workstation 240 can optionally take place after completing a corresponding scanning step.

The checking of one or all operating steps can alternatively also be performed independently of the system by an operator which then manually transfers the clearances to the system.

The formwork 10 is subsequently disposed in the exact position in the fourth workstation 240. If required, the formwork is correspondingly identified again. Furthermore, the installation parts, which the tubbing 500 to be correspondingly completed is now to contain, are correspondingly introduced into the prepared formwork. To this end, targeted tools 150 are again selected. Moving the robot 140 as well as the tool 150 again takes place by a combination of the potential steps of displacing the crossbeam 130, the base 131 in relation to the crossbeam 130, and the correspondingly controlled driving of the arms 141, the pivoting joints 142 and rotary joints 143, as well as of the drives 144 connected thereto.

A pre-fabricated protective element, peripheral seals, plastic installation parts, erector anchors, dewatering elements, temperature sensors, moisture sensors or the like can be introduced into the formwork 10, for example.

Corresponding grippers as a tool 150 to this end are connected to the robot 140. The robot 140 places the corresponding installation elements according to the positions stored in the data system, to which end said robot 140 obtains the corresponding control data from the memory-programmable controller. A reinforcement basket 151 or other reinforcement elements are furthermore introduced into the formwork 10 either manually or likewise in a controlled manner, for example by means of a crane (not illustrated).

The introduction can again be checked by a corresponding checking element.

Cover elements can additionally be attached and/or closed. Furthermore, renewed checking of the correct disposal of the lateral walls 14 and/or end walls 15 can optionally take place.

Once checked and cleared, the then completely prepared formwork 10 is transferred to the fifth workstation 250 in order for the concrete to be introduced into the prepared formwork 10.

In the fifth workstation 250, the formwork 10 is again disposed in the exact position and optionally detected as described above. The concrete composition and the concrete quantity is furthermore correspondingly prepared based on the tubbing 500 to be manufactured. This again preferably takes place based on the data of the data processing system in combination with the memory-programmable controller.

When concreting, it is furthermore expedient for further parameters such as, for example, temperature and moisture, to be detected so as to be able to determine the corresponding curing time, for example. This data, conjointly with the data in terms of the concrete composition and quantity, can then be used for controlling the operating steps along the curing line 320.

The compaction of the concrete in the formwork 10 can furthermore correspondingly take place in a known manner in the fifth workstation 250.

Depending on the requirement, a treatment of the surface of the agitated tubbing 500 and the removal of the covers can already take place here.

Here too, a corresponding checking step can additionally be carried out. If the latter is positive, as has been described above, the filled formwork 10 can then be transferred to the sixth workstation 260.

Once the formwork and/or the now filled tubbing are/is disposed in the exact position and optionally scanned or detected, respectively, the smoothing of the concrete surface of the tubbing 500 takes place either in the region not closed by the covers or across the entire face, for example when the covers are opened or removed. This can also take place in an automated manner, for example. To this end, a previously described displaceable robotic system with corresponding tools can also be used.

Once checked and cleared, the formwork 10 having the raw tubbing 500 situated therein is supplied to a curing line 320 of the curing tunnel 300 by way of the transverse conveyor 400, for example. Having passed through the curing tunnel 300 in a correspondingly controlled manner, the formwork 10 having the then pre-cured tubbing 500 is supplied to the first workstation 210 of the production line 200, for example by way of the further transverse conveyor 400.

It is obvious to the person skilled in the art that, depending on the respective requirements of the project, workstations and/or operating steps can be omitted, added, differently arranged or distributed. It is also possible for the aforementioned operating steps to be carried out only at one workstation, or on more or fewer workstations than described, respectively.

The control procedure of the method described above, or of the production plant 100, respectively, here takes place as described by means of a memory-programmable controller in which the corresponding operating steps and the associated positions of the robot 140 as well as of the respective tools 150 are stored or processed, respectively. This is combined with a corresponding data processing system/data storage system in which the corresponding parameters are stored, or to which the corresponding data of the sensors or detection tools, respectively, is added and correspondingly provided to the controller for carrying out the individual operating steps.

It is possible for the operational safety to be enhanced by way of the production plant 100 described above as well as the described method in conjunction with the described controller. Furthermore, material can be saved, wherein a precise and consistent use of the materials takes place. It is furthermore possible for a high and constant level of quality to be achieved and maintained. Furthermore, the production process for each individual tubbing can be documented with the corresponding checking data. In conjunction with the identification of the individual tubbing it is thus furthermore possible for the corresponding production process for each individual element in the completed tunnel to be documented. It is furthermore possible for the method and the production plant 100 to be continuously improved in a simple manner by modifications to the controller as well as changes to the tools, or for a re-use of the individual components to be enabled after the tunnel construction project has been completed.

FIGS. 16 to 23 show a second embodiment of a production plant 100 according to the invention. The production plant 100 here is embodied as a carousel plant, for example. A plant for producing reinforcement baskets 600, in which the reinforcements for the tubbings 500 can be produced in an automated manner, for example by means of welding robots, is disposed upstream of the production plant. The completed reinforcement baskets are temporarily stored in a reinforcement baskets store 700 so as to ensure that the tubbing production of the production plant 100 is delinked from delivery and quality issues of external reinforcement baskets producers. A store for the completed concrete tubbings is connected to the production plant 100, in which store said completed concrete tubbings achieve their final hardness for the installation in the tunnel by storage over time. The production plant 100 furthermore has a curing plant 300.

The production plant 100 here has a plurality of production lines 201, 202, 203. In this exemplary embodiment, the individual production lines 201, 202, 203 are in each case provided with a transport route 110. The transport route 110 has a track 111, here in the form of rails, on which the formworks 10 are displaceable, for example by way of wheels 29.

The production lines 201, 202, 203 have in each case workstations 210, 220, 230, 240, 250, 260 as described above, wherein the workstations 210 (opening of the formwork) and 220 (retrieving of the tubbing 500) are combined here. Furthermore disposed in parallel are the workstations 230 in which cleaning and preparing the formwork 10 for receiving the new reinforcement and the installation parts is provided. Likewise disposed in parallel are the workstations 240 in which the introduction of the reinforcement from the reinforcement store 700 takes place. Connected thereto is the concreting workstation 250 of the tubbing 500 in the formwork 10. The concrete is supplied from a concrete plant 900.

A smoothing station 260 for smoothing the surface of the tubbing 500 is subsequently provided. The stations 260 are likewise provided in parallel. A transverse conveyor 400 on which a travel element 410 is displaceable in the direction of the double arrow B is provided subsequently to the production lines 201, 202, 203. The formwork 10 can run on to the travel element 410 such that said formwork 10 can be supplied to a return conveyor 420. The latter also runs parallel to the production lines 201, 202, 203.

The production plant within the production lines 201, 202, 203 thus has 15 places where formworks 10 can be situated so that operating steps can be performed with the latter. A formwork 10 as a further storage point can be provided on the travel element 410. It is furthermore possible that a total of five further formworks 10 can be situated on the return conveyor 420 such that a total of 20 or 21 formworks 10 can be provided in the production plant when the travel element is also considered to be a storage place.

A further transverse conveyor 430 on which a travel element 440 is displaceable in the direction of the double arrow D is provided for retrieving a formwork from the return conveyor 420. A lifting device 450 which will be explained hereunder is provided on the travel element 440.

The transverse conveyor 430 is disposed in front of a curing plant 300. The curing plant 300 here is embodied as a “high-rack storage bay”. Said curing plant 300 preferably has three planes 301, 302, 303 which are formed by curing chambers 310 disposed on top and next to one another. According to one preferred exemplary embodiment, curing chambers are provided next to one another in the curing plant 300 such that in the case of three planes 301, 302, 303 a total of 39 curing chambers form the curing plant 300. In a revolving manner, 59 to 60 formworks 10 can thus be used in the plant previously described, for example.

The curing chambers 310 here are embodied in the manner of containers. The curing chambers 310 are preferably formed by standard containers. According to one teaching of the invention, the curing chambers 310 are either individual or combined in clusters, and particularly preferably provided with air conditioning (for regulating the temperature and moisture, not illustrated). Depending on how many containers have been combined to form a temperature-controlled cluster, the lateral walls, covers or floors of the curing chambers 30 are correspondingly omitted so as to guarantee a corresponding circulation of heat and moisture.

The individual curing chambers 310 can in each case be provided with doors which for retrieving or adding, respectively, the individual formworks 10 provided with tubbings 500 can be opened or closed. These here can be, for example, film doors or other vertically opening doors. The doors are not illustrated.

Elements of the travel route, such as rails, for example, on which the formworks 10 are displaceable are provided in the curing chambers 310, for example.

It is furthermore possible for further disposals of the curing chambers 310 to be provided. For example, it is also possible for the curing chambers behind one another so as to therefrom generate a curing tunnel with one or a plurality of levels.

It is a great advantage of the modular curing chambers thus constructed that the latter can be pre-fabricated as a standard element such that said pre-fabricated standard elements can be pre-produced and supplied to a production plant 100 to be erected for tubbings 500 such that the production period of the curing plant 300 is significantly reduced. Furthermore, the modular curing chambers are recyclable because the latter, upon completion of the tubbing production, can be retrieved as modules, refurbished and supplied to a new production plant.

A further advantage here is that the curing chambers 310, when the latter are embodied as containers, can be connected to one another using normal container connection means for disposing containers on top of one another and next to one another, such as twist locks or mid locks, or the like, for example, such that the assembly times of a curing plant 300 are significantly reduced. Furthermore, such standard connection parts are available in a cost-effective manner. Guying these containers using lashing gear is also correspondingly possible, for example.

Furthermore, the construction of the production plant of the second embodiment is in particular provided so as to be modular such that the component parts of the individual workstations, or individual workstations, can also be prefabricated and transported as entire modules. Also these after the completion of the tubbing production are removable, refurbishable and/or modifiable as modules, and able to be reused in a production plant to be newly erected.

Is the travel element 400 is displaceable in direction of the double arrow D. A lifting device 450 is disposed on the travel element 440. The lifting device 450 has a platform 460 on which formwork 10 is displaceable such that the latter is displaceable from the return conveyor 420 and into a corresponding curing chamber 310, or out of the latter and then in turn to one of the production lines 201, 202, 203. This is illustrated in FIGS. 17 to 21, for example. FIG. 20 here shows a lateral view of the lifting device 450, and FIG. 21 shows a lateral view of the short side of the lifting device 450. The vertical movement of the platform 460 here takes place by means of suitable drive means which are not illustrated. The same applies also to moving the formwork 10 onto the platform 460, or from the latter, respectively, for example.

The tracks 111 of the transport routes 110 of the production lines 201, 202, 203 are in each case provided with a drive 113, see in particular FIGS. 20 and 22. This drive enables the displacement of the formworks 10 in the production lines 201, 202, 203, for example. The return conveyor 420 is also correspondingly provided with a drive 114.

The workstations 230 disposed in parallel for cleaning and preparing the formwork 10, transversely to the transport route 110 of the production lines 201, 202, 203, have a travel route 120 so as to implement automation of these workstations 230. To this end, the travel route has two parallel tracks which are connected by a crossbeam 130. The crossbeam is displaceable in the direction of the double arrow E on the travel route 120. The tracks 122 per se are provided so as to be elevated on pillars 121. The crossbeam 130 here serves as a travel route for a base of a robot 140, as the latter has already been described above. The functionality of the robot 140 here is analogous. The same also applies to the changing of the tools.

A brush tool for cleaning and a spray tool for applying the release agent are preferably used here. The moving of the robot 140, the changing of the tools, as well as the disposing of the tools here are provided as has been described above. The point of differentiation here is only that three identical workstations disposed in parallel are served by the robot 140, wherein the travel route 120 here is provided so as to be transverse to the production line 201, 202, 203 and not longitudinally to the latter, as has been described above.

A gantry crane 241 which is displaceable horizontally in the X-direction and Y-direction is provided on the workstations 240. The gantry crane 241 here can be embodied such that said gantry crane 241 outside the production plant can receive reinforcement baskets, for example in the reinforcement baskets store 700, as is illustrated in FIG. 16, and then can introduce the reinforcement baskets into the interior space 17 of the respective formwork 10, for example.

The concreting station 250 also extends transversely to the production lines 201, 202, 203. A travel route 120 which is disposed above the formworks 10 is likewise provided within the concreting station 250. The travel route 120 here is divided into two in such a manner that an automatic cover for partially closing the formwork 10, or for partially closing the still open regions of the formwork 10, respectively, is provided on a first plane, for example. A pouring device (not illustrated) for the concrete is likewise provided so as to be displaceable above said automatic cover, said pouring device being displaceable along the travel route 120. The concreting of the tubbing takes place in an alternating manner such that concrete is introduced into the formwork 10 and the formwork then rests or is vibrated for a period. Depending on the production step, the cover and the pouring unit are correspondingly disposed above the three potential formworks in the concreting station.

FIG. 23 shows the workstations 260 in which smoothing of the surface of the concreted tubbing 500 in the interior space 17 of the formwork 10 is illustrated. The formwork per se has opened covers 50. A robot 160 which on a base 161 is displaceable along a travel route 162 which on the floor extends parallel to the formwork 10, or to the track 111, respectively, is disposed next to the formwork 10, or parallel to the track 111. The robot 160 has an articulated arm 163 which is disposed so as to be rotatable on the base 161. The tool 164 for smoothing the surface of the concrete tubbing 500 is provided on the front end of the articulated arm 163. This here can be a scraper or else a driven smoothing roller.

For smoothing the surface of the concrete tubbing 500, the tool 164 is placed on the surface at one of the two ends of the concrete tubbing 500 and moved two thirds across the surface, for example. This movement is subsequently repeated from the other end of the concrete tubbing 500. To this end, the robot 160 with the base 161 thereof is correspondingly displaced along the travel route 162. In order for each corresponding position to be reachable with the corresponding force on the tool 164, the robot 160, or the articulated arm 163, respectively, is correspondingly actuated.

When surfaces of particularly large tubbings 500 are to be processed, or when greater driving forces have to be applied, two robots 160 can also collaborate here. Accordingly, one robot 160 can be provided on each production line 201, 202, 203, or else only some of said production lines, in the station 260. Alternatively, in the case of an odd number of production lines, the robots can also be provided in each case only between two production lines.

FIGS. 24 to 26 show a third embodiment according to the invention of a production plant. Here, a production plant is shown in the stationary operation. Formworks 10 are disposed behind one another in rows 181, 182 on a place 180. The formworks advantageously are next to one another so as to be transverse to the rows. A robot 160 is in turn provided so as to be disposed on the place 180 between the rows 181, 182, the travel route unit 162 of said robot 160 extending along the rows 181, 182 and between the latter. The robot 160 per se here is in turn provided with an articulated arm 163 which is provided so as to be rotatable on a base 161 that is displaceable along the travel route 162. A tool 164, here illustrated as a cleaning brush, is disposed on the front end of the articulated arm 163 here. The tool, as has already been described above, is again replaceable. The disposal of the tools on the individual formworks or on the robot per se likewise takes place as has been described above. As a consequence of the construction of the robot, it is possible for the tool to reach each correspondingly required point on or in the formwork 10.

The workstations described above in a stationary plant are carried out as operating steps at the different formworks so as to depend on the processing state of the latter. This means that the robot 160, once the latter has cleaned a formwork and subsequently has oiled the latter, is displaced to the next formwork at which an operating step can be carried out, for example. Simultaneously, a reinforcement basket is introduced into this formwork just cleaned by way of a gantry crane, not illustrated, or any other working medium.

The completely prepared formwork per se can now be already concreted at another point. An already concreted formwork is in this instance, for smoothing the surface of the concrete tubbing, approached by a further robot 160 and the surface is smoothed as has been described above, for example.

If a formwork is filled with a finished raw tubbing of which the surface 520 has been treated, the formwork 10 after closing the covers 50 is retrieved from the site thereof and supplied to a curing plant 130, for example. The retrieval can take place by way of a lifting device, not illustrated.

Either an empty formwork or a formwork having a cured tubbing is then placed at the now vacant site, so as to subsequently either clean the empty formwork or to retrieve the cured tubbing once the formwork has been opened as described above.

Alternatively, a gantry system of the type described above, having one or a plurality of crossbeams which extend across both rows 181, 182 can also be provided, for example, one or else a plurality of displaceable robots 140 of the type described above being in each case situated on said crossbeam/crossbeams so as to then work on the formworks 10 from above. Different possibilities of disposing the travel routes 120 and crossbeams 130 are possible here, so that one or a plurality of robots 140 is/are capable of correspondingly reaching and processing all of the formworks 10.

The corresponding production method of the tubbings as described above, or as claimed, respectively, here is preferably adapted in a corresponding manner to the requirements of the individual three different embodiments of the production plants described above.

1-25. (canceled)

26. A production plant for producing concrete tubbing of a tunnel lining system, having at least one formwork for producing the concrete tubbing, wherein the production plant is one of:
a carousel plant using at least one operating step for producing the concrete tubbing with at least one production line having at least two workstations and having at least one transport route between the at least two workstations, or;
a stationary plant with at least two stationary formworks, wherein the required operating steps for producing the concrete tubbing are carried out on the formworks, and having at least one curing station for curing concrete filled into the formwork, comprising:
at least one robot for carrying out the at least one operating step at one of the at least two workstations or at least two formworks, wherein at least one travel route at least partially extends along or transversely to the at least one production line, or one of along or transversely to the formwork; and,
one travel element on which the at least one robot is disposed on a base, wherein the at least one robot is at least partially displaceable one of along or transversely to the at least one production line or formwork.

27. The production plant as claimed in claim 26, wherein the base of the at least one robot on the at least one travel element is movable along the travel element into the workstation.

28. The production plant as claimed in claim 26 wherein the travel route is one of on pillars, above the workstation or the formwork, or is disposed next to the workstation or the formwork.

29. The production plant as claimed in claim 26, wherein the travel route comprises at least one track on at least one at least one of along or transversely to the at least one production line or formwork.

30. The production plant as claimed in claim 29, wherein the travel element comprises a least one crossbeam, wherein at least one of;
the crossbeam ends are displaceable on a track; or,
the base of the at least one robot is disposed on the crossbeam to be displaceable across the workstation.

31. The production plant as claimed in claim 26 wherein the robot comprises a tool wherein the tool is movable and pivotable in the space of the workstation.

32. The production plant as claimed in claim 31, wherein the tool (150) is replaceable on the robot.

33. The production plant as claimed in claim 32, wherein the replaceable tool is contained in a storage space which is one of displaceable by the robot, situated on the workstation, or in the region of the formwork.

34. The production plant as claimed in claim 31 wherein the tool is at least one of a torque driver, a brush, a roller, a measurement verification element, a nozzle, a scanner, a gripper, or a camera.

35. The production plant as claimed in 26 wherein the at least one workstation is at least one of a station for opening or closing the formwork, or a cover of the formwork; a station for retrieving the concrete tubbing; a station for cleaning the formwork; a station for preparing the formwork for subsequently introducing concrete; a station for equipping the formwork with at least one element of the concrete tubbing; a station for verifying the measurements of the formwork; a station for filling the formwork with concrete; or a station for treating the surface of the introduced concrete of the concrete tubbing.

36. The production plant as claimed in claim 35, wherein the at least one element is at least one of a seal, a protective liner, a reinforcement element, a sensor including a temperature sensor, a dewatering element, a plastic element, or an erector anchor.

37. The production plant as claimed in claim 26 wherein at least two production lines are disposed in parallel and comprise at least two parallel workstations.

38. The production plant as claimed in claim 37, wherein the robot is displaceable between the at least two parallel workstations of the at least two parallel production lines.

39. The production plant as claimed in claim 26 wherein at least one production plant for making reinforcements for the tubbings is disposed upstream, and the tubbings are temporarily stored in a store.

40. The production plant as claimed in claim 26 wherein the at least one workstation is of modular construction.

41. The production plant as claimed in claim 26 wherein the curing station is constructed from individual curing chambers comprising a standard ISO container.

42. The production plant as claimed in claim 26 wherein the curing station comprises a plurality of planes disposed on top of one another.

43. A method for producing concrete tubbing of a tunnel lining system having at least one formwork, including a production plant as claimed in claim 26, the method comprising the following steps:
1. disposing at a precise position, formwork at least one of a location or in a respective workstation along at least one production line of the production plant;
2. identifying optionally at least one of the type of formwork in the workstation, or at the location;
3. picking up optionally the tool required for carrying out an operating step by the robot;
4. displacing a base of the robot along at least one of travel route or a crossbeam for X/Y-alignment with a position required for carrying out the operating step at one of the workstation or at the location;
5. carrying out and completing the operating step by the robot using a suitable tool;
6. checking optionally the completion of the operating step by the robot using a suitable tool;
7. repeating optionally steps 3 to 6 for carrying out a further operating step at one of the workstation or the location;
8. transporting the formwork to one of the next workstation or curing station;
9. repeating optionally steps 3 to 8 for carrying out an operating step at one of the next workstation or at the next formwork at the next location.

44. The method as claimed in claim 43 wherein the tool is at least one of a torque driver, a brush, a roller, a measurement verification element, a nozzle, a scanner, a gripper, or a camera.

45. The method as claimed in claim 43 wherein the at least one workstation is at least one of: a station for opening or closing at least one of the formwork or a cover of the formwork; a station for retrieving the concrete tubbing; a station for cleaning the formwork; a station for preparing the formwork for subsequently introducing concrete; a station for equipping the formwork with at least one element of the concrete tubbing; a station for verifying the measurements of the formwork; a station for filling the formwork with concrete; or a station for treating the surface of the introduced concrete of the concrete tubbing.

46. The method as claimed in claim 43 wherein the replaceable tool is at least one of retrieved from or deposited in a storage space which is one of displaceable by the robot or situated on the workstation.

47. The method as claimed in claim 43 including an operating step, comprising;
one of opening or closing one of the formwork or the cover of the formwork;
retrieving the concrete tubbing;
cleaning the formwork;
preparing the formwork for subsequently introducing concrete;
equipping the formwork with at least one element of the concrete tubbing;
verifying the measurements of the formwork;
filling the formwork with concrete; or,
treating the surface of the introduced concrete of the concrete tubbing.

48. The method as claimed in claim 47 wherein the at least one element is at least one of a seal, a protective liner, a reinforcement element, a sensor, including a temperature sensor, a dewatering element, a plastic element, or an erector anchor.

49. The method as claimed in claim 43 wherein the tool is at least one of a torque driver, a brush, a roller, a measurement verification element, a nozzle, a scanner, a gripper, or a camera.
